(19) United States
(12) Patent Application Publication
(10) Pub. No.: US 2025/0356445 A1
(43) Pub. Date: Nov. 20, 2025

(54) METHODS AND SYSTEMS OF FACILITATING AN AUTOMATED ASSET TRANSACTION

(71) Applicant: Klaviss Technologies Corp., Yorba Linda, CA (US)

(72) Inventors: Seth Paul Bradley, Oceanside, CA (US); Amrindra Flora, San Mateo, CA (US); David Amaral, Orange, CA (US); Jacob Repreza, Chino Hills, CA (US); Omid Yousofi, Costa Mesa, CA (US)

(21) Appl. No.: 19/210,970

(22) Filed: May 16, 2025

Related U.S. Application Data
(60) Provisional application No. 63/648,534, filed on May 16, 2024.

(51) Int. Cl. G06Q 50/16; G06Q 50/18; G06V 30/19

(52) U.S. Cl. CPC G06Q 50/167; G06Q 50/18; G06V 30/191

(57) ABSTRACT

The present disclosure provides a method of facilitating an automated asset transaction. Further, the method may include receiving an asset transaction data from a user device associated with a user. Further, the asset transaction data corresponds to a transaction associated with an asset. Further, the method may include processing the asset transaction data. Further, the method may include identifying a transaction characteristic data based on the processing. Further, the transaction characteristic data corresponds to a characteristic associated with the transaction. Further, the method may include storing the transaction characteristic data. Further, the method may include generating a transaction update data based on the transaction characteristic data. Further, the transaction update data corresponds to an update in relation to the transaction. Further, the generating may be further based on an AI module. Further, the method may include transmitting the transaction update data to the client device.

The current application claims a priority to the U.S. Provisional Patent application Ser. No. 63/648,534 filed on May 16, 2024.

### FIELD OF DISCLOSURE

The present disclosure relates to the field of data processing. More specifically, the present disclosure relates to methods and systems of facilitating an automated asset transaction.

### BACKGROUND

The real estate industry plays a pivotal role in the global economy, facilitating the purchase, sale, rental, and development of properties. It is a cornerstone of personal wealth accumulation, urban development, and economic growth, making it essential for efficient and transparent transaction processes.

In the realm of real estate transactions, effective communication, decision-making, compliance, and security are paramount to ensure smooth operations and protect all parties involved. While traditional methods have been in place, they often fall short in terms of efficiency, transparency, and compliance, leading to delays, errors, and potential security breaches.

One of the most critical aspects of real estate transactions is accurate and timely data extraction from various documents, such as property deeds, contracts, and transaction records. However, current manual methods are labor-intensive, prone to errors, and susceptible to fraud, often resulting in costly rework and compliance issues.

Furthermore, the lack of standardized documentation practices can complicate compliance with legal requirements, increasing the risk of non-compliance penalties and fraudulent activities. The need for efficient, secure, and transparent processes has become increasingly evident as the real estate market evolves.

Therefore, systems and methods that can enhance efficiency, transparency, and compliance in real estate transactions by automating data extraction and management processes are required. These improvements should address existing challenges while ensuring robust security and accurate decision-making to better serve all stakeholders involved in real estate transactions. Therefore, there is a need for improved methods and systems of facilitating an automated asset transaction.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating an automated asset transaction. Further, the method may include receiving, using a communication device, an asset transaction data from a user device associated with a user. Further, the asset transaction data corresponds to a transaction associated with an asset. Further, the method may include processing, using a processing device, the asset transaction data. Further, the method may include identifying, using the processing device, a transaction characteristic data based on the processing. Further, the transaction characteristic data corresponds to a characteristic associated with the transaction. Further, the method may include storing, using a storage device, the transaction characteristic data. Further, the method may include generating, using the processing device, a transaction update data based on the transaction characteristic data. Further, the transaction update data corresponds to an update in relation to the transaction. Further, the generating may be further based on an AI module. Further, the method may include transmitting, using the communication device, the transaction update data to the client device.

The present disclosure provides a system of facilitating an automated asset transaction. Further, the system may include a communication device. Further, the communication device may be configured for receiving an asset transaction data from a user device associated with a user. Further, the asset transaction data corresponds to a transaction associated with an asset. Further, the communication device may be configured for transmitting a transaction update data to the client device. Further, the system may include a processing device. Further, the processing device may be configured for processing the asset transaction data. Further, the processing device may be configured for identifying a transaction characteristic data based on the processing. Further, the transaction characteristic data corresponds to a characteristic associated with the transaction. Further, the processing device may be configured for generating the transaction update data based on the transaction characteristic data. Further, the transaction update data corresponds to an update in relation to the transaction. Further, the generating may be further based on an AI module. Further, the system may include a storage device which may be configured for storing the transaction characteristic data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating an automated asset transaction, in accordance with some embodiments.

FIG. 3B illustrates a continuation of the flowchart of the method 300 of facilitating an automated asset transaction, in accordance with some embodiments.

FIG. 4 illustrates a flowchart of a method 400 of facilitating an automated asset transaction including generating, using the processing device 904, a document extract data, in accordance with some embodiments.

FIG. 5 illustrates a flowchart of a method 500 of facilitating an automated asset transaction including generating, using the processing device 904, a modified transaction update data, in accordance with some embodiments.

FIG. 6 illustrates a flowchart of a method 600 of facilitating an automated asset transaction including processing, using the processing device 904, the additional insight data, in accordance with some embodiments.

FIG. 7 illustrates a flowchart of a method 700 of facilitating an automated asset transaction including training, using the processing device 904, the AI module to obtain a trained AI module, in accordance with some embodiments.

FIG. 8 illustrates a flowchart of a method 800 of facilitating an automated asset transaction including receiving, using the communication device 902, a regulatory data from the regulatory database, in accordance with some embodiments.

FIG. 9 illustrates a block diagram of a system 900 of facilitating an automated asset transaction, in accordance with some embodiments.

FIG. 10 is a flow diagram of a method for facilitating managing real estate transactions using artificial intelligence, in accordance with some embodiments.

FIG. 11 is a flow diagram of a method for facilitating managing real estate transactions using artificial intelligence, in accordance with some embodiments.

FIG. 12 is a flow diagram of a method for facilitating managing real estate transactions using artificial intelligence, in accordance with some embodiments.

FIG. 13 is a flow diagram of a method for facilitating managing real estate transactions using artificial intelligence, in accordance with some embodiments.

FIG. 14 is a flow diagram of a method for facilitating managing real estate transactions using artificial intelligence, in accordance with some embodiments.

FIG. 15 is a flow diagram of a method for facilitating managing real estate transactions using artificial intelligence, in accordance with some embodiments.

FIG. 16 is a continuation flow diagram of FIG. 15.

FIG. 17 is a flow diagram of a method for facilitating managing real estate transactions using artificial intelligence, in accordance with some embodiments.

FIG. 18 is a continuation flow diagram of FIG. 17.

FIG. 19 is a continuation flow diagram of FIG. 18.

FIG. 20 is a continuation flow diagram of FIG. 19.

FIG. 21 is a continuation flow diagram of FIG. 20.

FIG. 22 is a flow diagram of a method for facilitating managing real estate transactions using artificial intelligence, in accordance with some embodiments.

FIG. 23 is a flow diagram of a method for facilitating managing real estate transactions using artificial intelligence, in accordance with some embodiments.

FIG. 24 is a flow diagram of a method for facilitating managing real estate transactions using artificial intelligence, in accordance with some embodiments.

FIG. 25 is a flow diagram of a method for facilitating managing real estate transactions using artificial intelligence, in accordance with some embodiments.

FIG. 26 is a continuation flow diagram of FIG. 25.

FIG. 27 is a flow diagram of a method for facilitating managing real estate transactions using artificial intelligence, in accordance with some embodiments.

FIG. 28 is a continuation flow diagram of FIG. 27.

FIG. 29 is a continuation flow diagram of FIG. 28.

FIG. 30 is a continuation flow diagram of FIG. 29.

FIG. 31 is a continuation flow diagram of FIG. 30.

FIG. 32 is a flow diagram of a method for facilitating managing real estate transactions using artificial intelligence, in accordance with some embodiments.

FIG. 33 is a flow diagram of a method for facilitating managing real estate transactions using artificial intelligence, in accordance with some embodiments.

FIG. 34 is a flow diagram of a method for facilitating managing real estate transactions using artificial intelligence, in accordance with some embodiments.

FIG. 35 is a flow diagram of a method for facilitating managing real estate transactions using artificial intelligence, in accordance with some embodiments.

FIG. 36 is a flow diagram of a method for facilitating managing real estate transactions using artificial intelligence, in accordance with some embodiments.

FIG. 37 is a flow diagram of a method for facilitating managing real estate transactions using artificial intelligence, in accordance with some embodiments.

FIG. 38 is a flow diagram of a method for facilitating managing real estate transactions using artificial intelligence, in accordance with some embodiments.

FIG. 39 is a flow diagram of a method for facilitating managing real estate transactions using artificial intelligence, in accordance with some embodiments.

FIG. 40 is a flow diagram of a method for facilitating managing real estate transactions using artificial intelligence, in accordance with some embodiments.

FIG. 41 is a flow diagram of a method for facilitating managing real estate transactions using artificial intelligence, in accordance with some embodiments.

FIG. 42 illustrates a status associated with the real estate transaction, in accordance with some embodiments.

FIG. 43 is a flow diagram of a method for facilitating managing real estate transactions using artificial intelligence, in accordance with some embodiments.

FIG. 44 is a continuation flow diagram of FIG. 43.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems for facilitating managing real estate transactions using artificial intelligence. Further, Klaviss, an exemplary embodiment of the disclosed system herein, may provide a real estate tech platform. Further, the disclosed system may use Artificial Intelligence (AI) and OCR (optical character recognition) to scan real estate documents and extract all data relevant to completing a real estate transaction, including but not limited to, buyers, sellers, agents, escrow, title information, inspection reports, all contingencies, check boxes status, signatures, initials, signing ceremonies, important dates, purchase price, special terms, and so on. Klaviss consolidates all parties for communication and action, adds a unique transaction ID, and includes a security feature to reduce instances of fraud.

Further, the disclosed system may automate the real estate transaction and improve it by adding more machine learning and AI algorithms in addition, the disclosed system may be configured for enabling a user or client to also make voice commands to start and close the transaction.

Further, the disclosed system may be configured for helping clients manage transactions and compliance with advanced automation.

Further, Klaviss uses a unique process of scanning real estate documents utilizing OCR and extracting the information which is then uploaded to an AI engine associated with the disclosed system for decision processing. The AI engine interprets the data and makes decisions to notify the appropriate parties in the transaction (via SMS or Email) to take the next steps in a purchase transaction. The disclosed system may use the data to determine timelines either for various deadlines, task/transaction extensions or when to reset reminder communications. Further, the disclosed system may also adjust pricing and inspect signatures for compliance.

Further, the disclosed AI-OCR model may be trained to become a real estate expert, eventually becoming an alternative to a human broker, and help buyers and sellers with purchasing a home without needing to rely on a human broker. Further, this may save substantial amounts of money for the buyer and seller as a result.

Furthermore, using current real-estate contractual documents, and industry websites (APIs), and inputting expert knowledge, the disclosed system may use OCR-AI (including computer vision) to train the disclosed model to read this entire knowledge base, and draw answers/non-legal advice to answer questions a buyer or seller may pose as they embark on their home buying journey. Further, the disclosed OCR-AI mode may be trained to run a transaction, replacing the human transaction coordinator; and make it efficient, smoother, open, and transparent for the clients, meanwhile vastly reducing their transaction costs.

Further, the disclosed system may include fundamental development tools such as NODE JS, React, AWS, Generative AI Models, Mongo DB, etc. Further, non-tech components associated with the disclosed system may include real estate documents, real estate industry sites, expert knowledge, and FAQs.

Further, the disclosed system may use AI and OCR (optical character recognition) to scan contractual documents and extract all data relevant to completing a business transaction. Such data may include, but is not limited to, the parties, dates, contingencies, requirements, obligations, terms, prices, deposits, checked/unchecked boxes, signatures/initials/signing ceremonies, etc. In connection with its ideal iteration in the real estate industry, the parties may specifically include, but are not limited to, buyers, sellers, sellers' agents/brokers, buyers' agents/brokers, escrow officers, title officers, mortgage brokers, lender representatives and underwriters and transaction coordinators (“Real Estate Parties”), and such other data can specifically include but is not limited to, escrow and title information, inspection reports, contingencies, purchase price, special terms, deposit amounts, property information, etc.

The disclosed system may use the data to create timelines to set deadlines, set terms, create time sensitive and ordered task lists, create extensions for tasks and other deal checkpoints, and set and reset automated reminder communications. Furthermore, the software adjusts pricing, deposits, and renegotiation offer and acceptance amounts.

The disclosed system may inspect signatures and initials for signatures for compliance and to create orderly signing ceremonies for future documents.

Klaviss consolidates all parties for communication and action, adds a unique transaction ID, and includes a security feature to reduce instances of fraud.

Further, in some embodiments, the disclosed system may leverage one or more specialized Large Language Models (LLMs) specifically trained on a large corpus of documents associated with real estate transactions. Further, the one more specialized LLMs may also be specifically trained with documents associated with a certain jurisdiction (e.g. district level, state level, country level and so on). Accordingly, an accuracy of prediction and/or output generated by the one or more specialized LLMs may be superior as compared to a generic LLM.

Additionally, in some embodiments, the one or more specialized LLMs may also be trained on metadata associated with the documents. Such metadata may include, for example, but is not limited to, contextual data such as time data, location data, motion data, environmental data (such as temperature, pressure, sound level, light level, etc.), hardware configuration data, software configuration data and so on that may be associated with one or more users associated with the documents, one or more user devices associated with the one or more users, one or more organizations associated with the documents, or any other entity that stores, handles and/or manipulates the documents at any stage of the life-cycle of the documents. Accordingly, during inference of the one or more specialized LLMs, one or more sensors (e.g. sensors located in user devices and/or IoT devices, smart appliances, smart home hub etc.) may be employed to capture contextual data and be fed as part of input to the specialized LLMs in order to further enhance the accuracy of prediction.

Additionally, the system may also leverage a distributed vector database implemented on the blockchain in order to provide Retrieval Augmented Generation (RAG) in conjunction with the specialized one or more LLMs. Accordingly, new documents which were not part of the training corpus may be dynamically identified based on contextual criteria and ingested into the system thus allowing the one or more specialized LLMs to operate (e.g. answer questions, prompt actionable items, execute actions, etc.) based on a continuously updated knowledge base.

In some embodiments, a system for facilitating managing real estate transactions using artificial intelligence is disclosed. Further, the system may include a communication device configured for receiving at least one data from at least one device. Further, the at least one device may include a smartphone, a tablet, a laptop, a scanner, etc. Further, the at least one device may be configured for generating the at least one data based on scanning at least one document associated with a real estate transaction of at least one real estate property. Further, the communication device may be configured for transmitting a notification to at least one second user device associated with the at least one party. Further, the at least one party may include buyers, sellers, agents, escrow officers, etc. Further, the at least one second user device may include a smartphone, a tablet, a laptop, a personal computer, etc.

Further, the system may include a processing device configured for analyzing the at least one data based on at least one artificial intelligence model.

Further, the processing device may be configured for extracting at least one real estate information based on the analyzing. Further, the at least one artificial intelligence model may be configured for extracting the at least one real estate information. Further, the at least one real estate information may facilitate completing a real estate transaction. Further, the at least one real estate information may include buyer information, seller information, agent information, escrow officer information, title information, inspection reports, all contingencies, check boxes status, signatures, initials, signing ceremonies, important dates, purchase price, special terms, and so on. Further, the processing device may be configured for determining a status of the real estate transaction based on the at least one real estate information. Further, the status corresponds to a step occurring during the real estate information. Further, the at least one real estate information may reflect the step. Further, the processing device may be configured for generating the notification based on the status. Further, the notification may notify at least one party (via SMS or Email) to take at least one successive step in the real estate transaction. Further, the at least one successive step may be preceded by the step.

Further, in some embodiments, data corresponding to the real estate transactions may be stored on a distributed ledger, such as a blockchain. Thus, a greater degree of transparency, traceability and security may be provided to users. Accordingly, the processing device may be further configured to execute one or more smart contracts associated with various stages of one or more real estate transactions.

In some embodiments, a method for facilitating managing real estate transactions using artificial intelligence is disclosed. Further, the method may include receiving, using a communication device, at least one data from at least one device. Further, the at least one device may include a smartphone, a tablet, a laptop, a scanner, etc. Further, the at least one device may be configured for generating the at least one data based on scanning at least one document associated with a real estate transaction of at least one real estate property.

Further, the method may include analyzing, using a processing device, the at least one data based on at least one artificial intelligence model.

Further, the method may include extracting, using the processing device, at least one real estate information based on the analyzing. Further, the at least one artificial intelligence model may be configured for extracting the at least one real estate information. Further, the at least one real estate information may facilitate completing a real estate transaction. Further, the at least one real estate information may include buyer information, seller information, agent information, escrow officers, title information, inspection reports, all contingencies, check boxes status, signatures, initials, signing ceremonies, important dates, purchase price, special terms, and so on.

Further, in some embodiments, the method may include a step of executing one or more smart contracts associated with a blockchain network in order to facilitate managing of the real estate transactions. Accordingly, a greater degree of automation may be provided.

In some embodiments, the platform may leverage advanced AI-powered tools to automatically recognize and extract structured data from various document formats, such as property deeds, contracts, and transaction records. For instance, the system can analyze hand-written signatures using optical character recognition (OCR) technology paired with signature verification algorithms to ensure authenticity.

In some embodiments, the platform may integrate real-time data synchronization protocols that automatically update cloud storage with extracted data from local documents. This ensures seamless data flow and immediate accessibility for stakeholders.

In some embodiments, the platform may utilize blockchain technology to create a decentralized, immutable record of extracted data. Each extracted field, such as property values or transaction dates, is cryptographically hashed and stored on the blockchain for verification purposes.

In some embodiments, the platform may analyze the extracted data to generate contextual notifications tailored to individual parties' roles and interests. For instance, a buyer may receive alerts about payment deadlines, while a seller may get reminders about document submissions.

In some embodiments, the platform may incorporate a legal rule engine that automatically checks extracted data against current regulations and standards. For example, the system could verify whether deposits meet minimum thresholds or if contract terms comply with local laws.

In some embodiments, the platform may analyze unstructured text within documents to identify sentiment and key themes, such as customer satisfaction levels or areas of concern. This data can then be used to refine strategies and improve service delivery.

In some embodiments, the platform may integrate biometric authentication methods, such as facial recognition or fingerprint verification, to secure sensitive data within documents. This ensures that only authorized parties can access or modify the information, further safeguarding against unauthorized use.

In some embodiments, the platform may generate augmented reality (AR) visualizations based on extracted data, such as property measurements or layout details. Clients can view the virtual property in 3D, providing a more engaging and informative experience.

In some embodiments, the platform may utilize blockchain technology to enable remote notarization. Extracted data from documents is hashed and stored on the blockchain, creating an immutable record that serves as official proof of the transaction's authenticity. This eliminates the need for physical documents and streamlines the process.

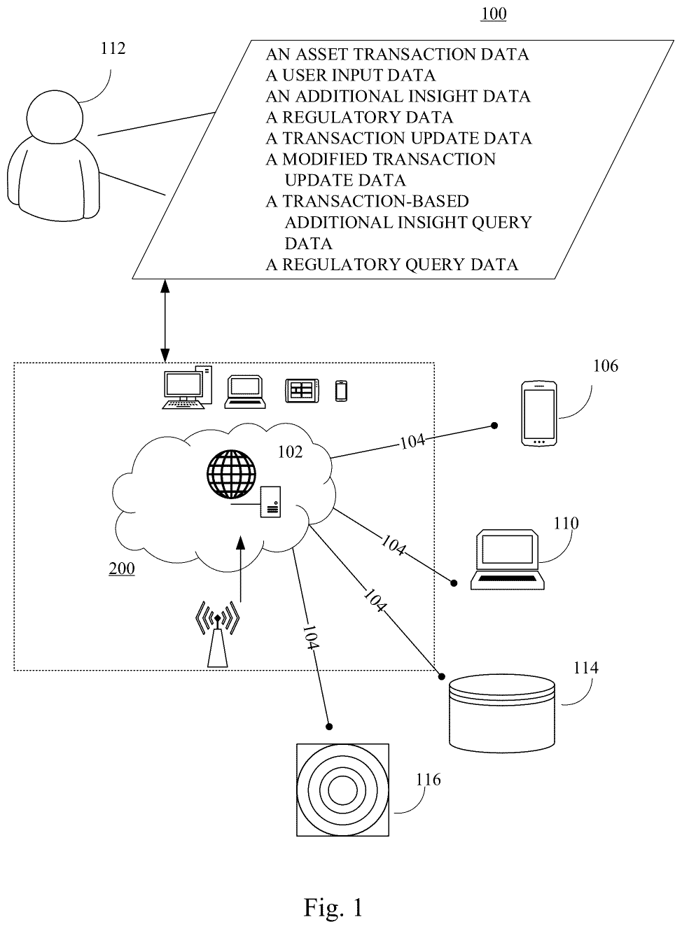

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

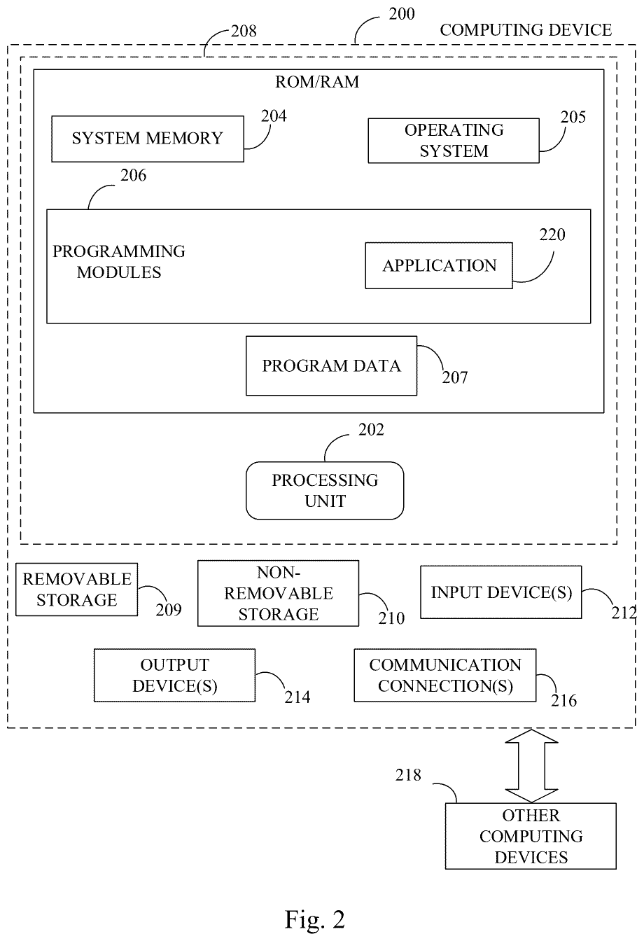

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

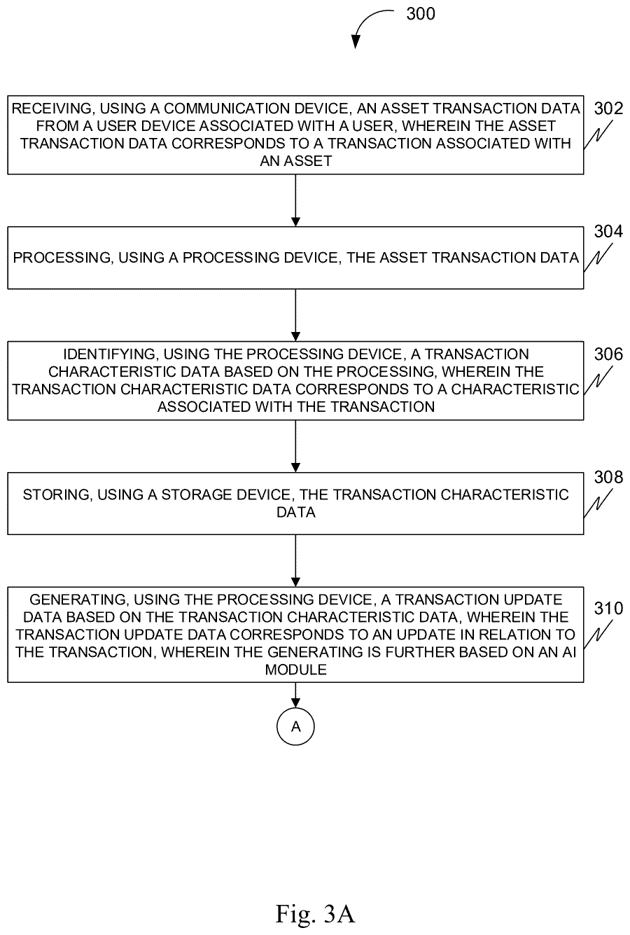

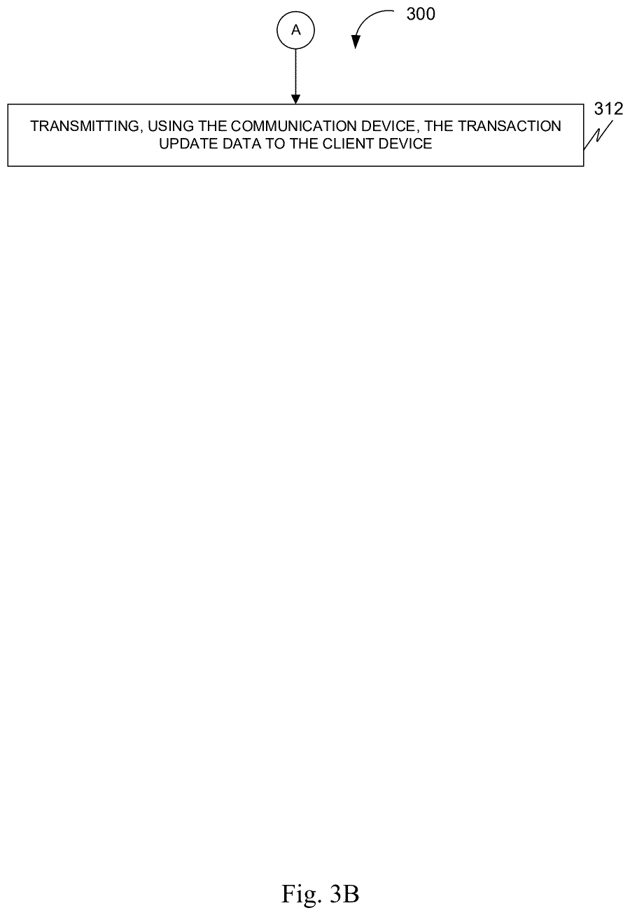

FIG. 3A and FIG. 3B illustrate a flowchart of a method 300 of facilitating an automated asset transaction, in accordance with some embodiments.

Accordingly, the method 300 may include a step 302 of receiving, using a communication device 902, an asset transaction data from a user device 908 associated with a user. Further, the asset transaction data corresponds to a transaction associated with an asset. Further, the method 300 may include a step 304 of processing, using a processing device 904, the asset transaction data. Further, the method 300 may include a step 306 of identifying, using the processing device 904, a transaction characteristic data based on the processing. Further, the transaction characteristic data corresponds to a characteristic associated with the transaction. Further, the method 300 may include a step 308 of storing, using a storage device 906, the transaction characteristic data. Further, the method 300 may include a step 310 of generating, using the processing device 904, a transaction update data based on the transaction characteristic data. Further, the transaction update data corresponds to an update in relation to the transaction. Further, the generating may be further based on an AI module. Further, the method 300 may include a step 312 of transmitting, using the communication device 902, the transaction update data to the client device.

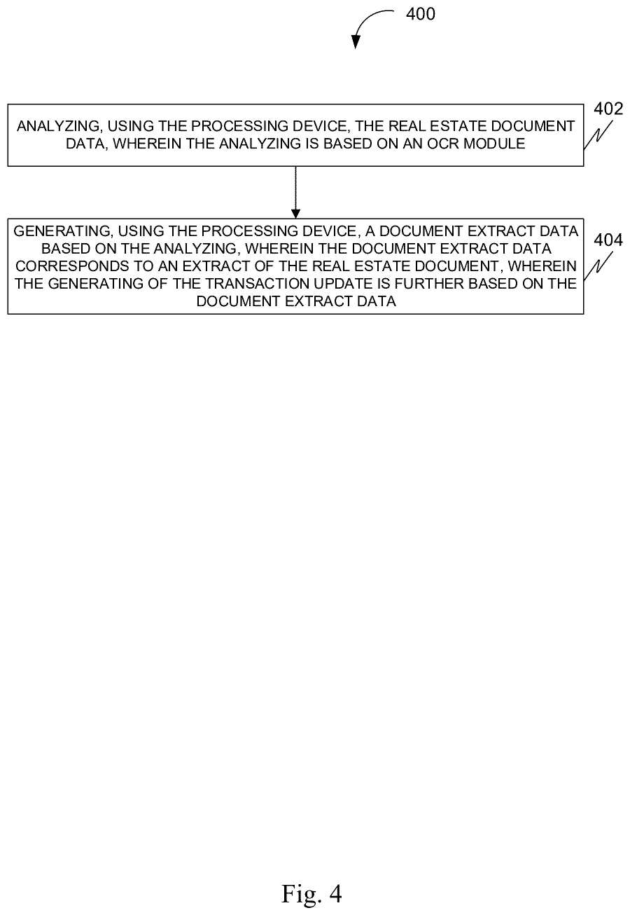

FIG. 4 illustrates a flowchart of a method 400 of facilitating an automated asset transaction including generating, using the processing device 904, a document extract data, in accordance with some embodiments.

Further, in some embodiments, the asset may include a real estate asset. Further, the asset transaction data may include a real estate document data corresponding to a document associated with the real estate asset. Further, the method 400 further may include a step 402 of analyzing, using the processing device 904, the real estate document data. Further, the analyzing may be based on an OCR module. Further, the asset may include a real estate asset. Further, the method 400 further may include a step 404 of generating, using the processing device 904, a document extract data based on the analyzing. Further, the document extract data corresponds to an extract of the real estate document. Further, the generating of the transaction update may be further based on the document extract data.

In some embodiments, the method 300 may further include generating, using the processing device 904, a transaction ID data based on the identifying of the transaction characteristic data. Further, the transaction ID data represents a transaction ID associated with the transaction. Further, the transaction ID data may be comprised in the transaction update data.

In some embodiments, each of the generating of the transaction update data and the storing of the transaction characteristic data may be based on an execution of a smart contract. Further, the smart contract may be associated with a block-chain network.

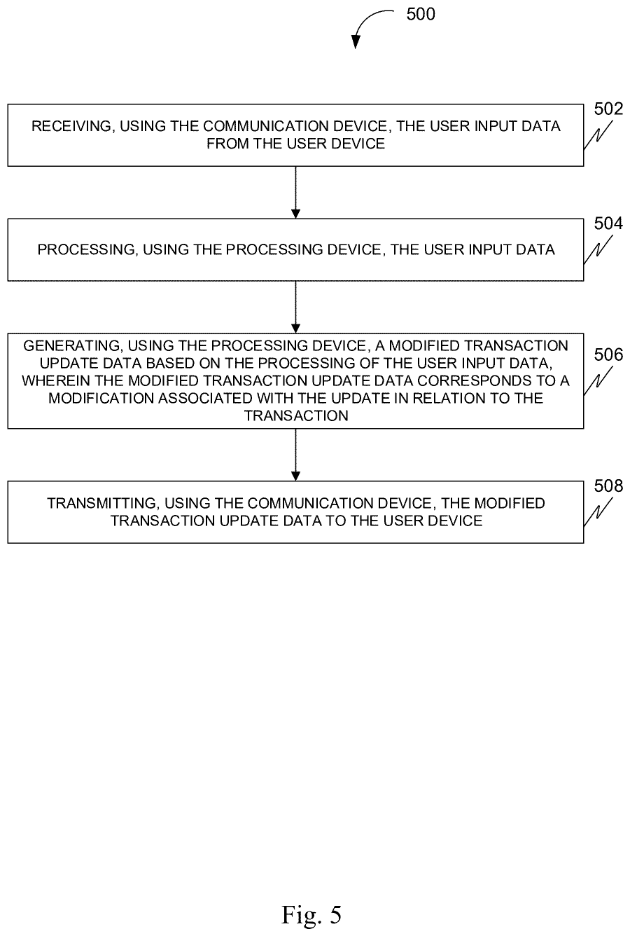

FIG. 5 illustrates a flowchart of a method 500 of facilitating an automated asset transaction including generating, using the processing device 904, a modified transaction update data, in accordance with some embodiments.

Further, in some embodiments, the user device 908 may include a user presentation device may be configured for presenting the transaction update data to the user. Further, the user device 908 further may include a user input device may be configured for generating a user input data corresponding to a user input in relation to the transaction. Further, the user device 908 further may include a user communication device may be configured for transmitting the user input data to the communication device 902. Further, the method 500 further may include a step 502 of receiving, using the communication device 902, the user input data from the user device 908. Further, the user device 908 further may include a user input device may be configured for generating a user input data corresponding to a user input in relation to the transaction. Further, the method 500 further may include a step 504 of processing, using the processing device 904, the user input data. Further, the user device 908 further may include a user input device may be configured for generating a user input data corresponding to a user input in relation to the transaction. Further, the method 500 further may include a step 506 of generating, using the processing device 904, a modified transaction update data based on the processing of the user input data. Further, the modified transaction update data corresponds to a modification associated with the update in relation to the transaction. Further, the user device 908 further may include a user input device may be configured for generating a user input data corresponding to a user input in relation to the transaction. Further, the method 500 further may include a step 508 of transmitting, using the communication device 902, the modified transaction update data to the user device 908.

In some embodiments, the asset transaction data includes a user data corresponding to the user associated with the transaction. Further, the method 300 further comprising validating, using the processing device 904, the user data. Further, the generating of the transaction update data may be further based on the validating. Further, the user data includes one or more of a user name data corresponding to a name associated with the user and a user signature data corresponding to a signature associated with the user.

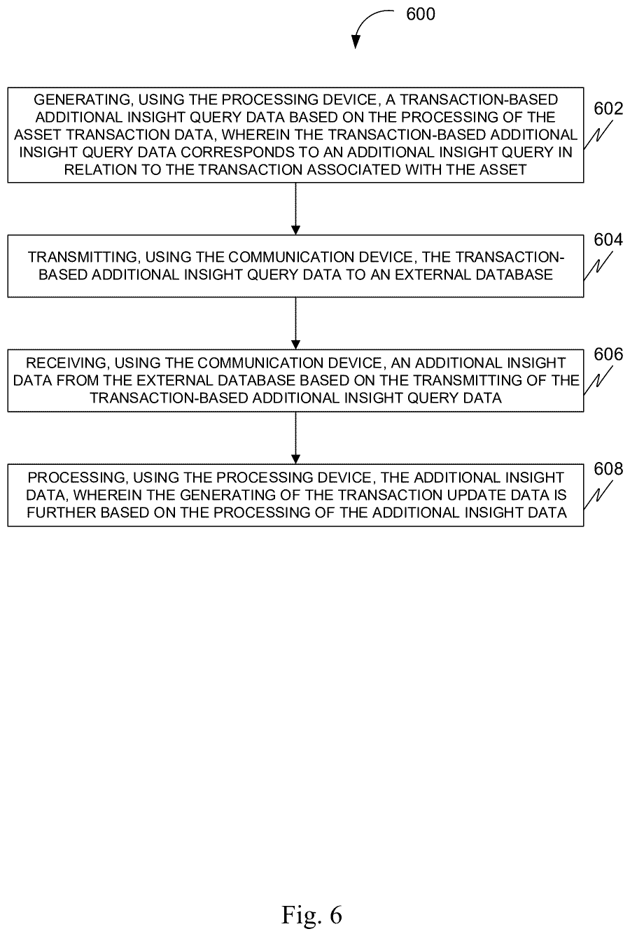

FIG. 6 illustrates a flowchart of a method 600 of facilitating an automated asset transaction including processing, using the processing device 904, the additional insight data, in accordance with some embodiments.

Further, in some embodiments, the method 600 further may include a step 602 of generating, using the processing device 904, a transaction-based additional insight query data based on the processing of the asset transaction data. Further, the transaction-based additional insight query data corresponds to an additional insight query in relation to the transaction associated with the asset. Further, in some embodiments, the method 600 further may include a step 604 of transmitting, using the communication device 902, the transaction-based additional insight query data to an external database. Further, in some embodiments, the method 600 further may include a step 606 of receiving, using the communication device 902, an additional insight data from the external database based on the transmitting of the transaction-based additional insight query data. Further, in some embodiments, the method 600 further may include a step 608 of processing, using the processing device 904, the additional insight data. Further, the generating of the transaction update data may be further based on the processing of the additional insight data.

In some embodiments, the method 300 may further include generating, using the processing device 904, a legal advisory data based on the processing of the asset transaction data. Further, the generating of the legal advisory data may be based on the AI module. Further, the legal advisory data may be comprised in the transaction update data.

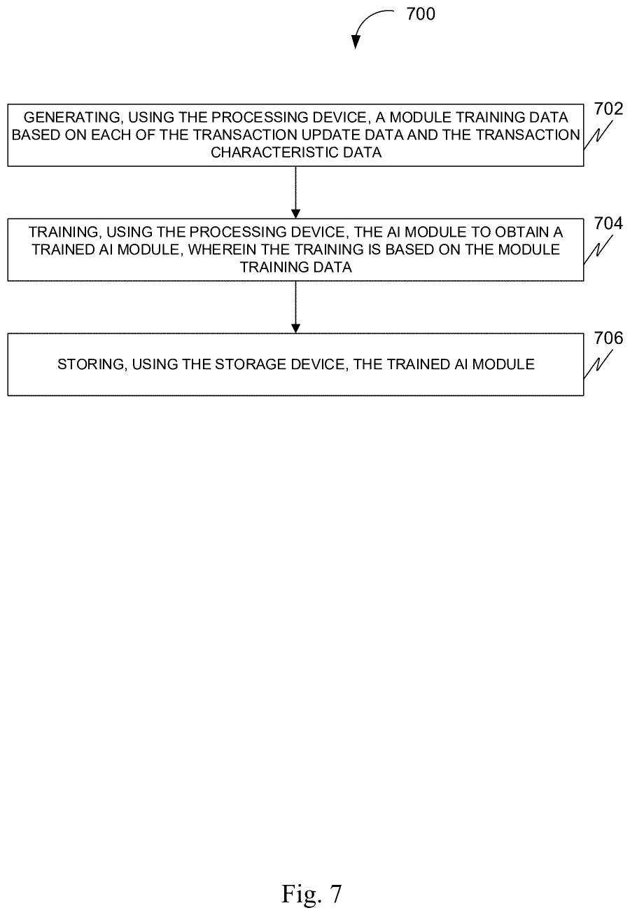

FIG. 7 illustrates a flowchart of a method 700 of facilitating an automated asset transaction including training, using the processing device 904, the AI module to obtain a trained AI module, in accordance with some embodiments.

Further, in some embodiments, the method 700 further may include a step 702 of generating, using the processing device 904, a module training data based on each of the transaction update data and the transaction characteristic data. Further, in some embodiments, the method 700 further may include a step 704 of training, using the processing device 904, the AI module to obtain a trained AI module. Further, the training may be based on the module training data. Further, in some embodiments, the method 700 further may include a step 706 of storing, using the storage device 906, the trained AI module.

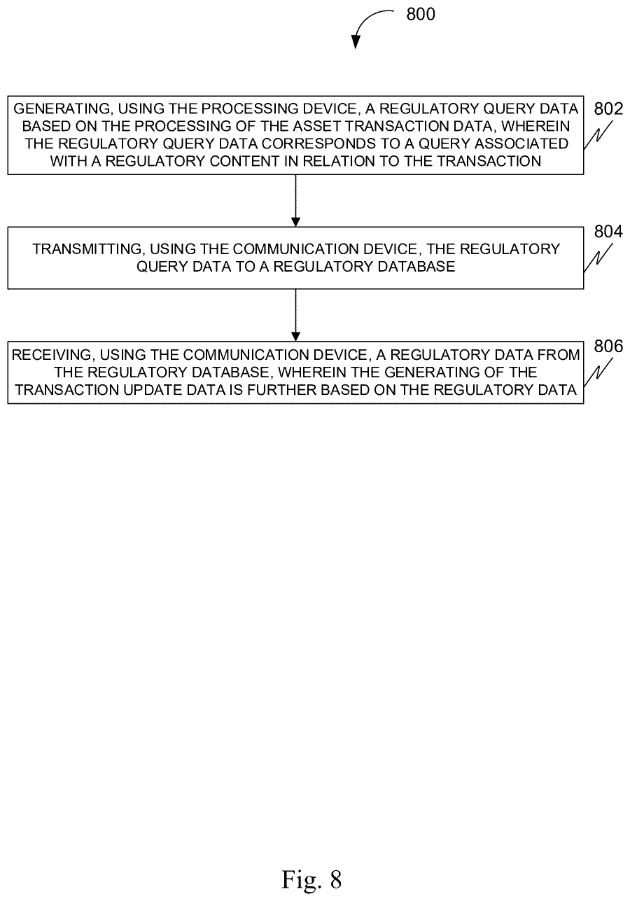

FIG. 8 illustrates a flowchart of a method 800 of facilitating an automated asset transaction including receiving, using the communication device 902, a regulatory data from the regulatory database, in accordance with some embodiments.

Further, in some embodiments, the method 800 further may include a step 802 of generating, using the processing device 904, a regulatory query data based on the processing of the asset transaction data. Further, the regulatory query data corresponds to a query associated with a regulatory content in relation to the transaction. Further, in some embodiments, the method 800 further may include a step 804 of transmitting, using the communication device 902, the regulatory query data to a regulatory database. Further, in some embodiments, the method 800 further may include a step 806 of receiving, using the communication device 902, a regulatory data from the regulatory database. Further, the generating of the transaction update data may be further based on the regulatory data.

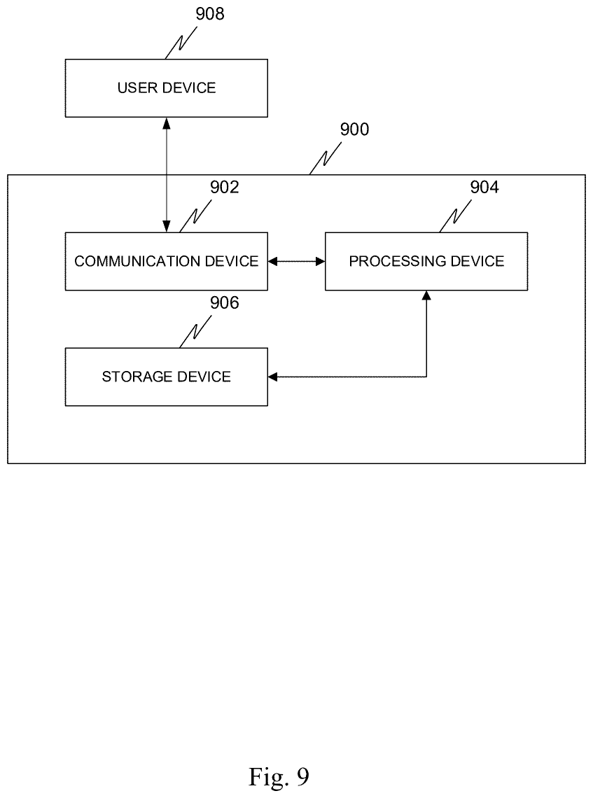

FIG. 9 illustrates a block diagram of a system 900 of facilitating an automated asset transaction, in accordance with some embodiments.

Accordingly, the system 900 may include a communication device 902. Further, the communication device 902 may be configured for receiving an asset transaction data from a user device 908 associated with a user. Further, the asset transaction data corresponds to a transaction associated with an asset. Further, the communication device 902 may be configured for transmitting a transaction update data to the client device. Further, the system 900 may include a processing device 904. Further, the processing device 904 may be configured for processing the asset transaction data. Further, the processing device 904 may be configured for identifying a transaction characteristic data based on the processing. Further, the transaction characteristic data corresponds to a characteristic associated with the transaction. Further, the processing device 904 may be configured for generating the transaction update data based on the transaction characteristic data. Further, the transaction update data corresponds to an update in relation to the transaction. Further, the generating may be further based on an AI module. Further, the system 900 may include a storage device 906 which may be configured for storing the transaction characteristic data.

Further, in some embodiments, the asset may include a real estate asset. Further, the asset transaction data may include a real estate document data corresponding to a document associated with the real estate asset. Further, the processing device 904 may be further configured for analyzing the real estate document data. Further, the analyzing may be based on an OCR module. Further, the asset may include a real estate asset. Further, the processing device 904 may be further configured for generating a document extract data based on the analyzing. Further, the document extract data corresponds to an extract of the real estate document. Further, the generating of the transaction update may be further based on the document extract data.

In some embodiments, the processing device 904 may be further configured for generating a transaction ID data based on the identifying of the transaction characteristic data. Further, the transaction ID data represents a transaction ID associated with the transaction. Further, the transaction ID data may be comprised in the transaction update data.

In some embodiments, each of the generating of the transaction update data and the storing of the transaction characteristic data may be based on an execution of a smart contract. Further, the smart contract may be associated with a block-chain network.

Further, in some embodiments, the user device 908 may include a user presentation device may be configured for presenting the transaction update data to the user. Further, the user device 908 further may include a user input device may be configured for generating a user input data corresponding to a user input in relation to the transaction. Further, the user device 908 further may include a user communication device may be configured for transmitting the user input data to the communication device 902. Further, the communication device 902 may be further configured for receiving the user input data from the user device 908. Further, the user device 908 further may include a user input device may be configured for generating a user input data corresponding to a user input in relation to the transaction. Further, the communication device 902 may be further configured for transmitting a modified transaction update data to the user device 908. Further, the processing device 904 may be further configured for. Further, the user device 908 further may include a user input device may be configured for generating a user input data corresponding to a user input in relation to the transaction. Further, the communication device 902 may be further configured for processing the user input data. Further, the user device 908 further may include a user input device may be configured for generating a user input data corresponding to a user input in relation to the transaction. Further, the communication device 902 may be further configured for generating the modified transaction update data based on the processing of the user input data. Further, the modified transaction update data corresponds to a modification associated with the update in relation to the transaction.

In some embodiments, the asset transaction data includes a user data corresponding to the user associated with the transaction. Further, the processing device 904 may be further configured for validating the user data. Further, the generating of the transaction update data may be further based on the validating. Further, the user data includes one or more of a user name data corresponding to a name associated with the user and a user signature data corresponding to a signature associated with the user.

Further, in some embodiments, the processing device 904 may be further configured for generating a transaction-based additional insight query data based on the processing of the asset transaction data. Further, the transaction-based additional insight query data corresponds to an additional insight query in relation to the transaction associated with the asset. Further, the processing device 904 may be further configured for processing an additional insight data. Further, the generating of the transaction update data may be further based on the processing of the additional insight data. Further, the communication device 902 may be further configured for. Further, the processing device 904 may be further configured for transmitting the transaction-based additional insight query data to an external database. Further, the processing device 904 may be further configured for receiving the additional insight data from the external database based on the transmitting of the transaction-based additional insight query data.

In some embodiments, the processing device 904 may be further configured for generating a legal advisory data based on the processing of the asset transaction data. Further, the generating of the legal advisory data may be based on the AI module. Further, the legal advisory data may be comprised in the transaction update data.

Further, in some embodiments, the processing device 904 may be further configured for generating a module training data based on each of the transaction update data and the transaction characteristic data. Further, the processing device 904 may be further configured for training the AI module to obtain a trained AI module. Further, the training may be based on the module training data. Further, the storage device 906 may be further configured for storing the trained AI module.

Further, in some embodiments, the processing device 904 may be further configured for generating a regulatory query data based on the processing of the asset transaction data. Further, the regulatory query data corresponds to a query associated with a regulatory content in relation to the transaction. Further, the communication device 902 may be further configured for transmitting the regulatory query data to a regulatory database. Further, the processing device 904 may be further configured for generating a regulatory query data based on the processing of the asset transaction data. Further, the communication device 902 may be further configured for receiving a regulatory data from the regulatory database. Further, the generating of the transaction update data may be further based on the regulatory data.

In some embodiments, the transaction characteristic data includes one or more of a buyer data, a seller data, an agent data, an escrow officer data, an inspection report data, a contingency data, a check-box status data, a relevant date data, a purchase price data and a transaction term data. Further, the buyer data corresponds to a buyer associated with the transaction. Further, the seller data corresponds to a seller associated with the transaction. Further, the agent data corresponds to an agent associated with the transaction. Further, the escrow officer data corresponds to an escrow officer associated with the transaction. Further, the inspection report data corresponds to an inspection report associated with the asset in relation to the transaction. Further, the contingency data corresponds to a contingency associated with the transaction. Further, the check-box status data corresponds to a status in relation to a check-box associated with the transaction. Further, the relevant date data corresponds to a relevant data associated with the transaction. Further, the purchase price data corresponds to a purchase price associated with the asset in relation to the transaction. Further, the transaction term data corresponds to a term associated with the transaction in relation to the asset.

In some embodiments, the transaction update data includes a signing ceremony data corresponding to a signing ceremony associated with the transaction in relation to the asset.

In some embodiments, the user input data includes a user audio input data corresponding to an audio input associated with the user. Further, the audio input includes a voice command associated with the user.

In some embodiments, the transmitting of the transaction update data may be based on one or more of a SMS communication protocol and an email communication protocol.

In some embodiments, the method 300 may further include identifying, using the processing device 904, a transaction timeline data based on the processing of the asset transaction data. Further, the transaction timeline data corresponds to a timeline associated with the transaction. Further, the generating of the transaction update data may be based on a transaction timeline data.

In some embodiments, the transaction timeline data includes one or more of a transaction deadline data and a transaction extension data. Further, the transaction deadline data corresponds to a deadline associated with the transaction. Further, the transaction extension data corresponds to an extension in relation to the transaction.

In some embodiments, the transaction update data includes a transaction update notification data corresponding to a notification in relation to the update associated with the transaction.

In some embodiments, the asset transaction data includes an asset contractual document data corresponding to a contractual document associated with the asset.

In some embodiments, the AI module includes an LLM-based AI module.

In some embodiments, the module training data in relation to the LLM-based AI module includes a jurisdictional level transaction data corresponding to the transaction associated with the asset comprised in a jurisdiction.

In some embodiments, the jurisdiction includes one or more of a district level jurisdiction, a state level jurisdiction and a country level jurisdiction.

In some embodiments, the module training data in relation to the LLM-based AI module further includes a transaction metadata corresponding to a metadata in relation to the transaction.

In some embodiments, the transaction metadata further includes one or more of a time data, a location data, a motion data, an environmental data, a hardware configuration data and a software configuration data associated with the transaction in relation to the asset.

In some embodiments, the environmental data includes one or more of a temperature data, a pressure data, a sound level data and a light level data associated with the asset.

In some embodiments, the transaction characteristic data includes a transactional anomaly data corresponding to an anomaly associated with the transaction in relation to the asset.

In some embodiments, the asset transaction data includes an asset image data corresponding to an image content associated with the asset.

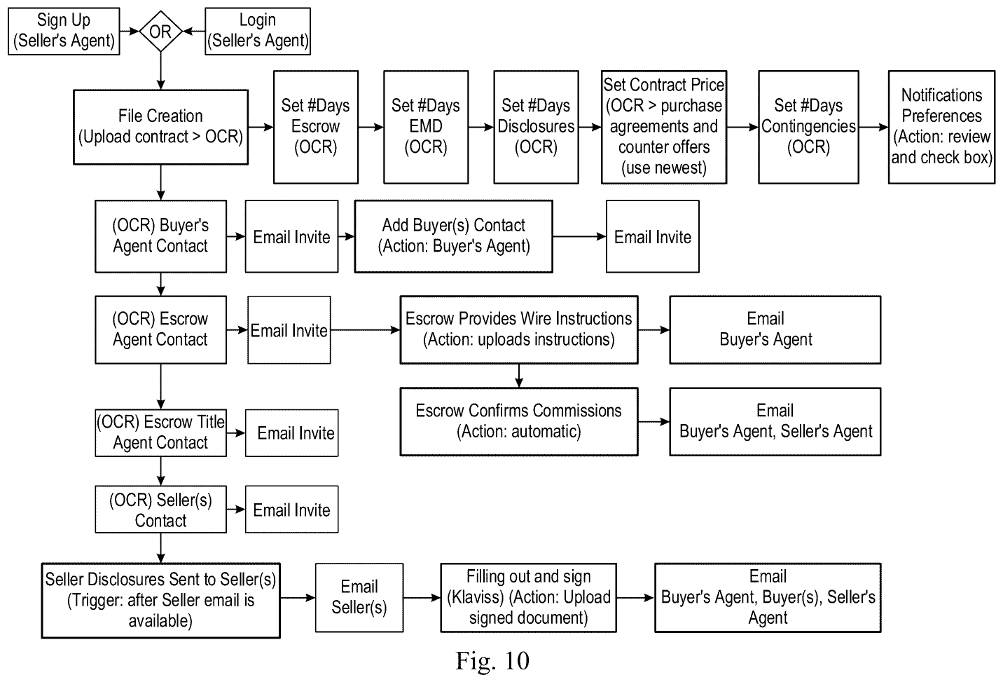

FIG. 10 is a flow diagram of a method for facilitating managing real estate transactions using artificial intelligence, in accordance with some embodiments.

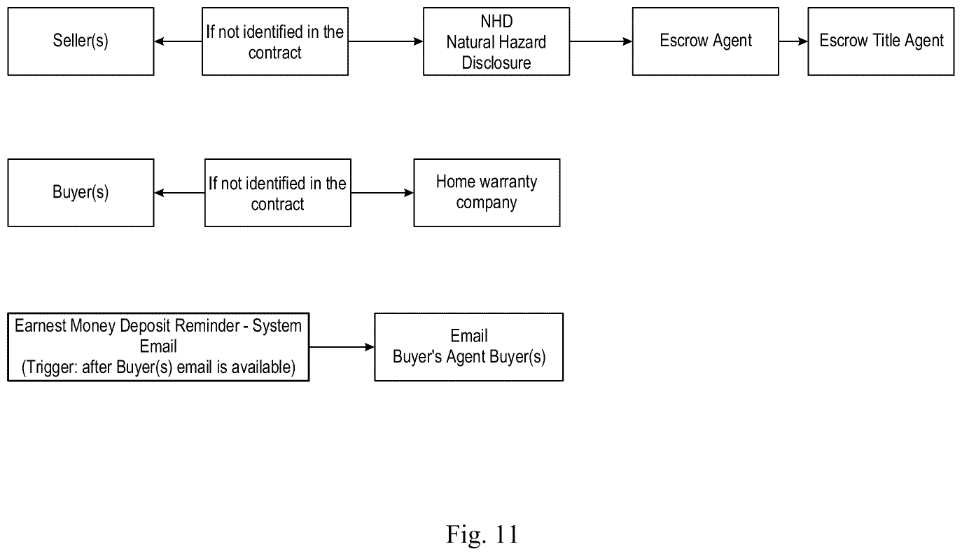

FIG. 11 is a flow diagram of a method for facilitating managing real estate transactions using artificial intelligence, in accordance with some embodiments.

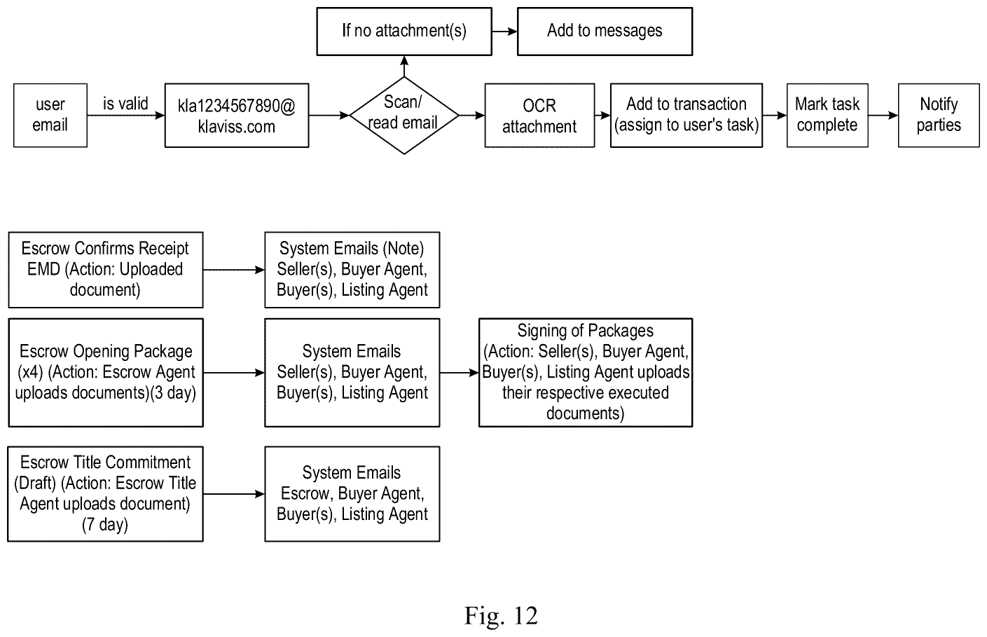

FIG. 12 is a flow diagram of a method for facilitating managing real estate transactions using artificial intelligence, in accordance with some embodiments.

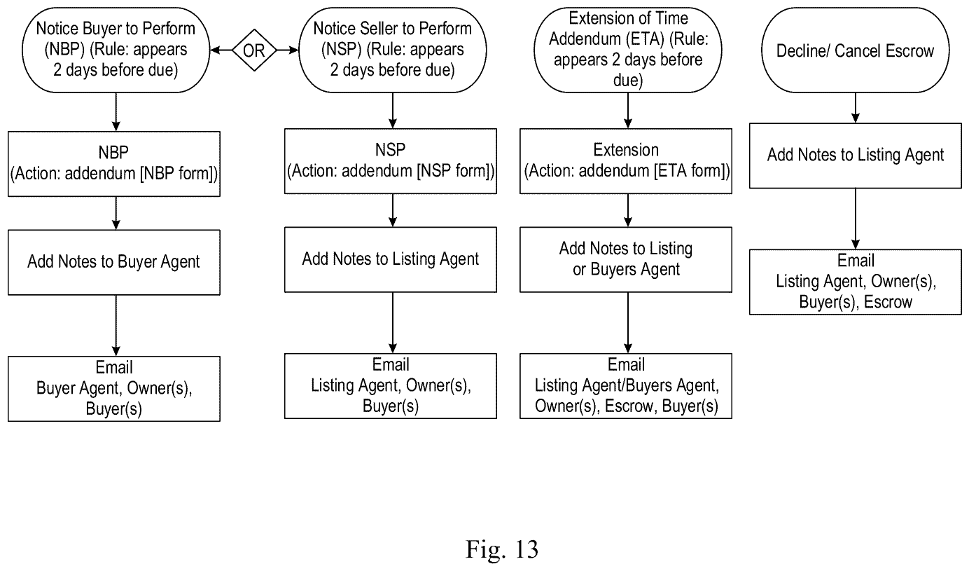

FIG. 13 is a flow diagram of a method for facilitating managing real estate transactions using artificial intelligence, in accordance with some embodiments.

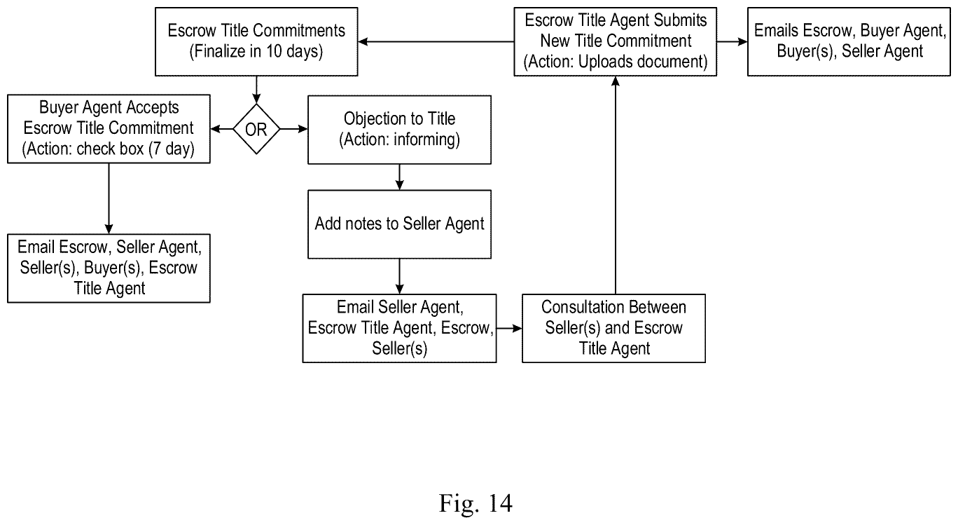

FIG. 14 is a flow diagram of a method for facilitating managing real estate transactions using artificial intelligence, in accordance with some embodiments.

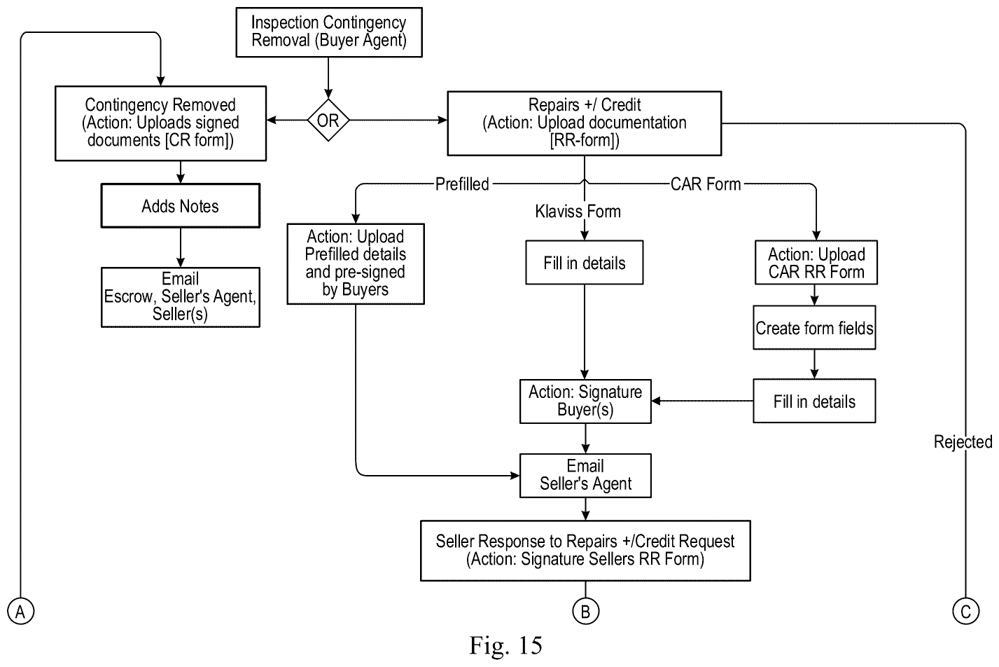

FIG. 15 is a flow diagram of a method for facilitating managing real estate transactions using artificial intelligence, in accordance with some embodiments.

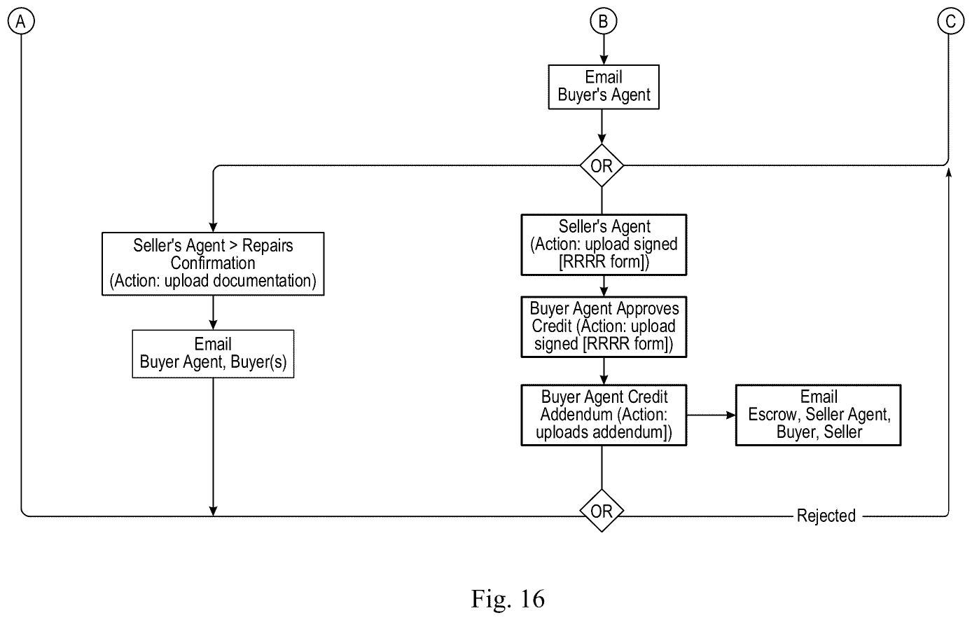

FIG. 16 is a continuation flow diagram of FIG. 15.

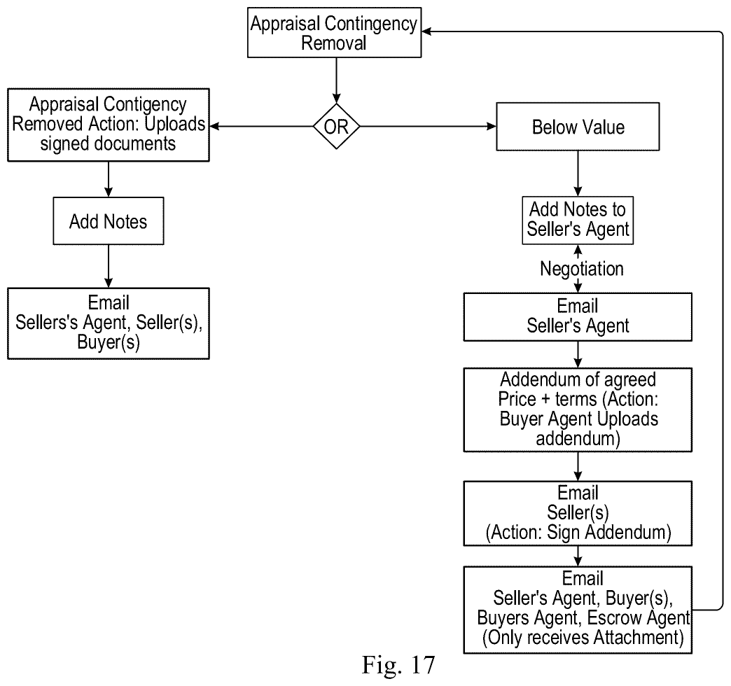

FIG. 17 is a flow diagram of a method for facilitating managing real estate transactions using artificial intelligence, in accordance with some embodiments.

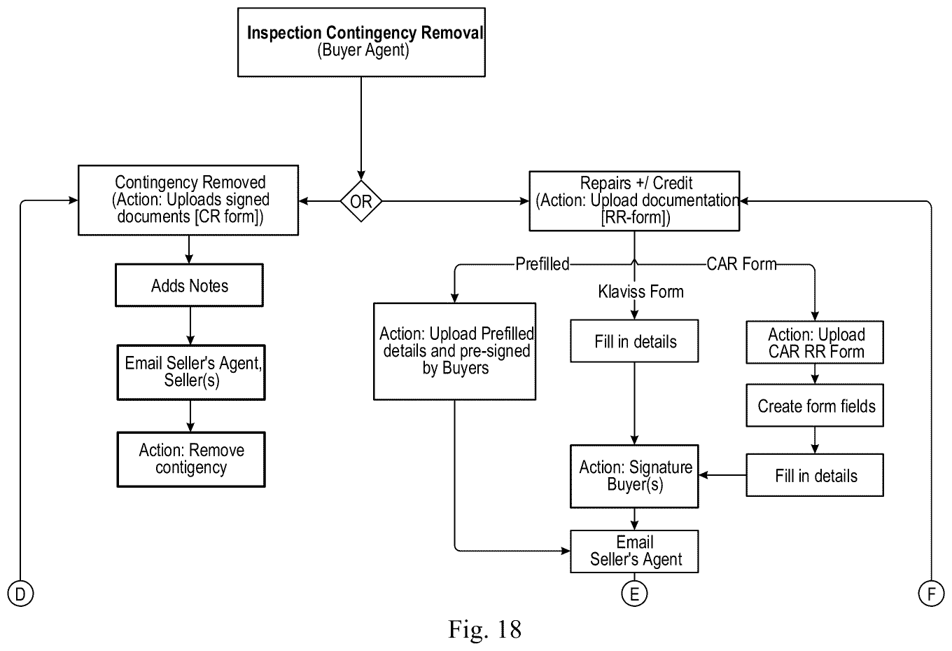

FIG. 18 is a continuation flow diagram of FIG. 17.

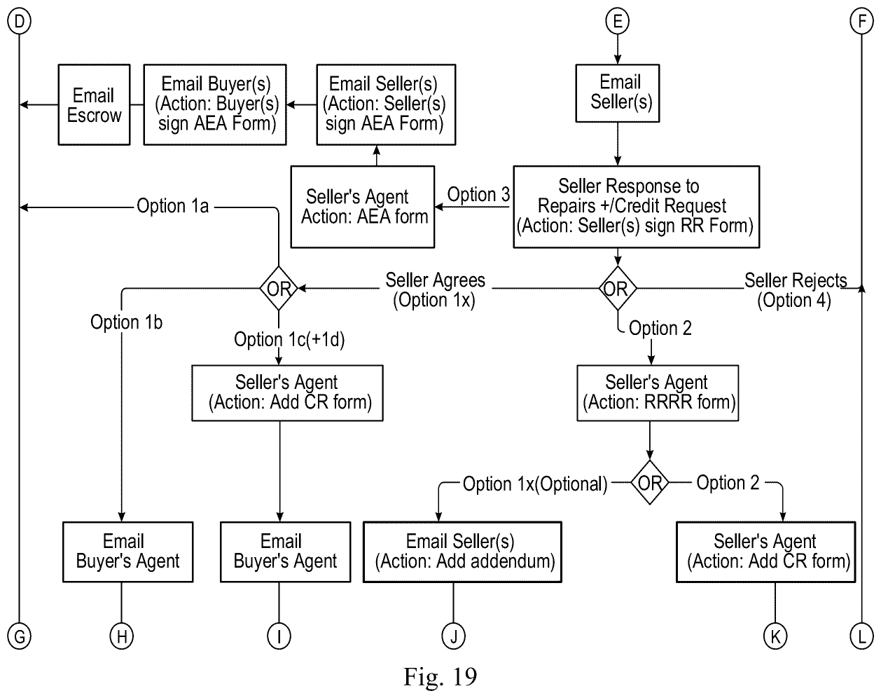

FIG. 19 is a continuation flow diagram of FIG. 18.

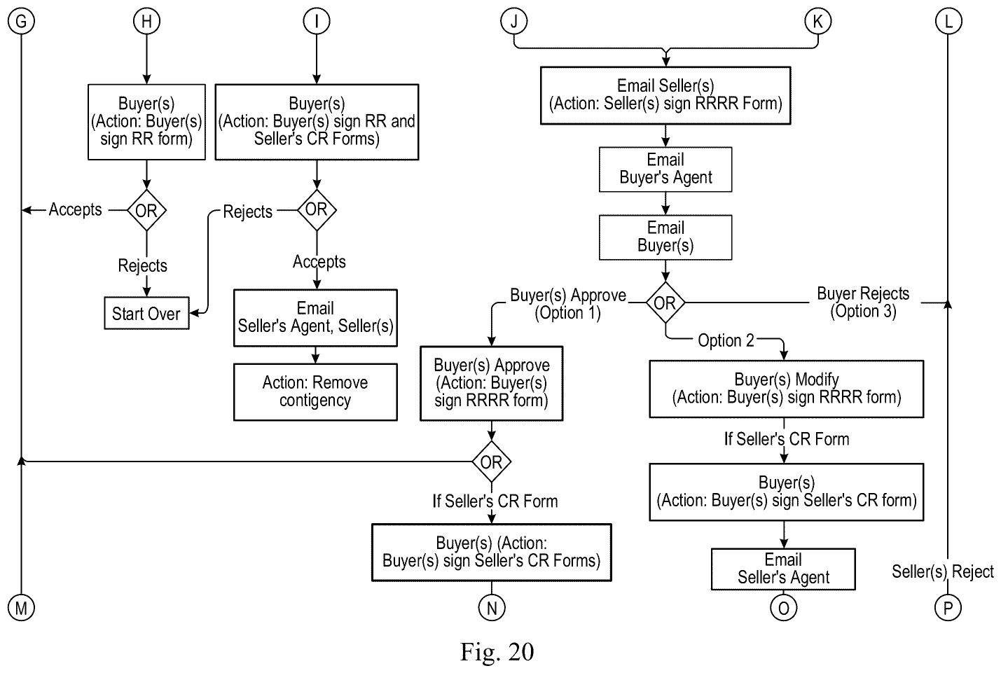

FIG. 20 is a continuation flow diagram of FIG. 19.

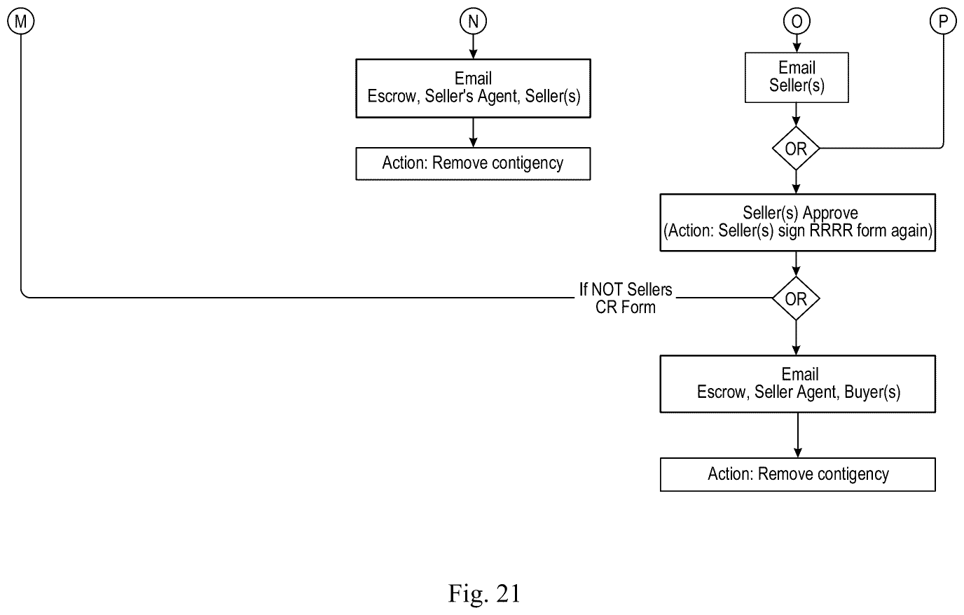

FIG. 21 is a continuation flow diagram of FIG. 20.

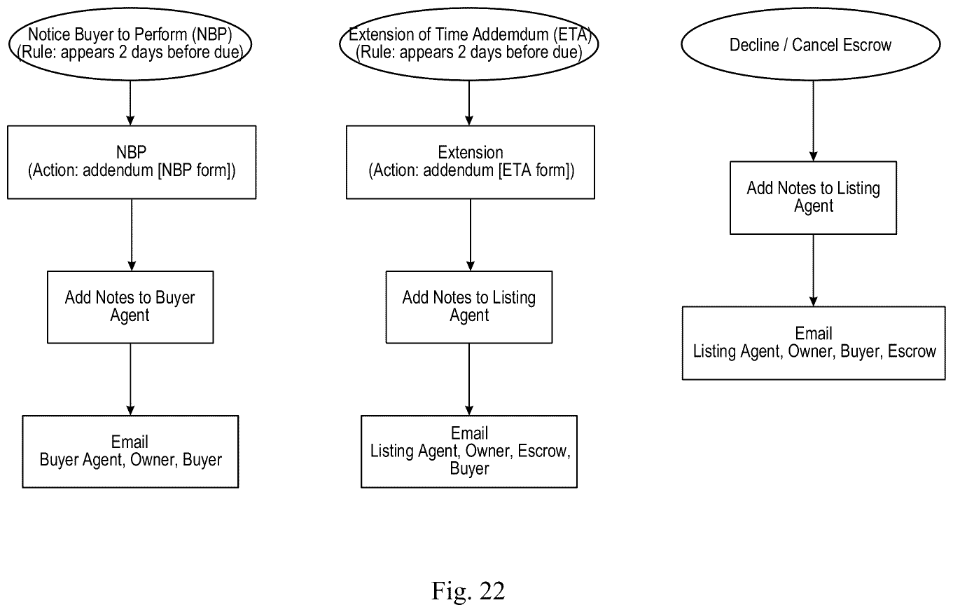

FIG. 22 is a flow diagram of a method for facilitating managing real estate transactions using artificial intelligence, in accordance with some embodiments.

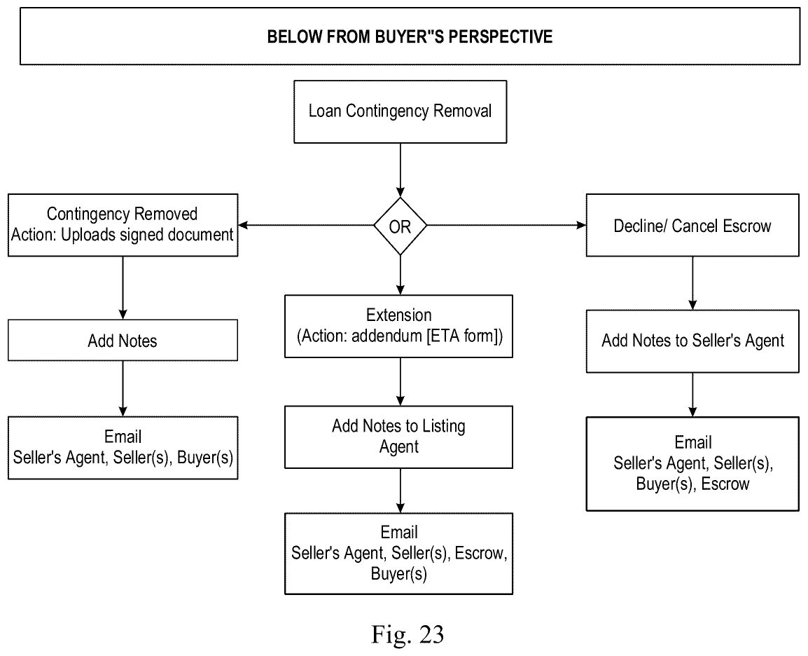

FIG. 23 is a flow diagram of a method for facilitating managing real estate transactions using artificial intelligence, in accordance with some embodiments.

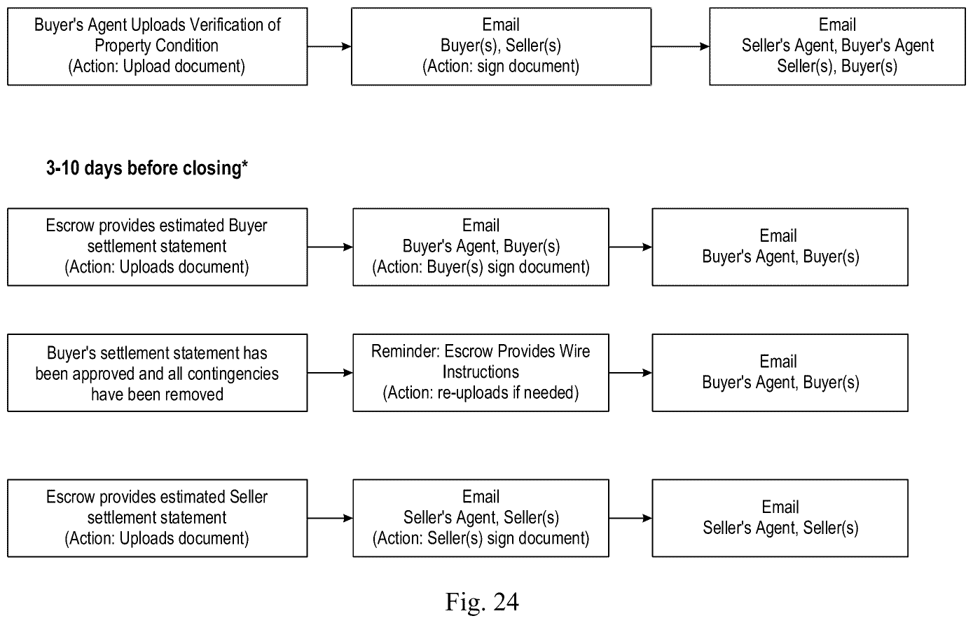

FIG. 24 is a flow diagram of a method for facilitating managing real estate transactions using artificial intelligence, in accordance with some embodiments.

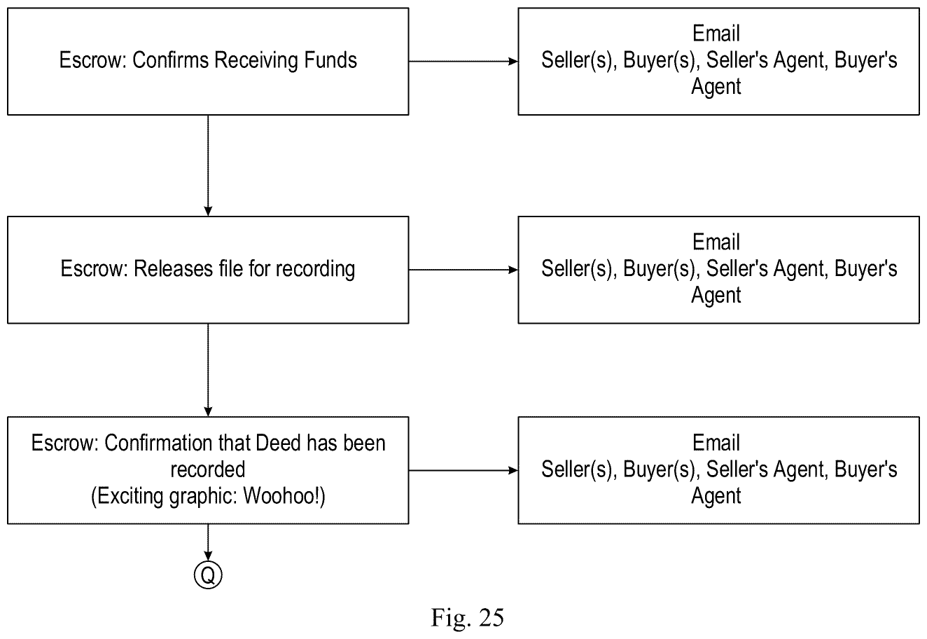

FIG. 25 is a flow diagram of a method for facilitating managing real estate transactions using artificial intelligence, in accordance with some embodiments.

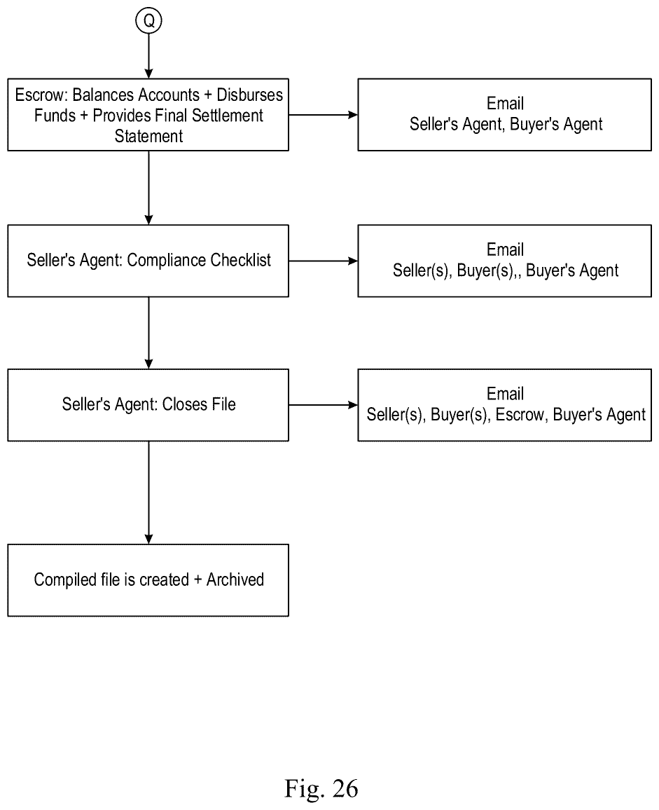

FIG. 26 is a continuation flow diagram of FIG. 25.

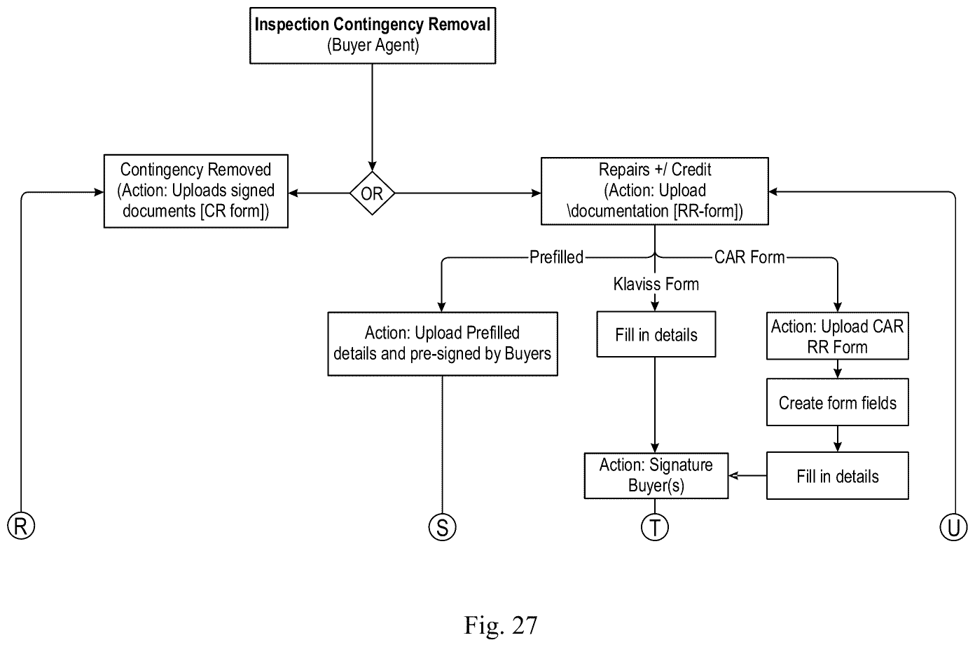

FIG. 27 is a flow diagram of a method for facilitating managing real estate transactions using artificial intelligence, in accordance with some embodiments.

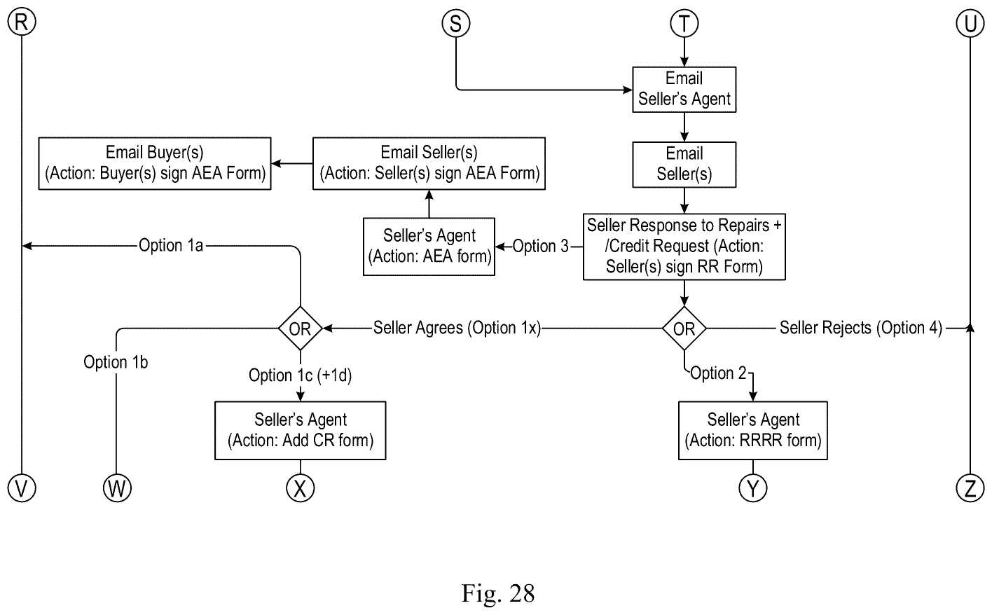

FIG. 28 is a continuation flow diagram of FIG. 27.

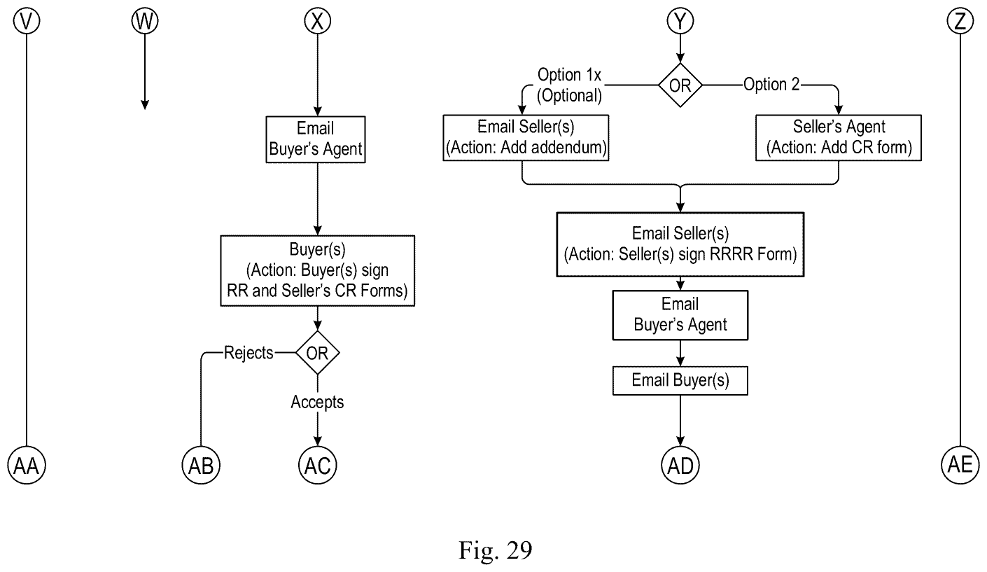

FIG. 29 is a continuation flow diagram of FIG. 28.

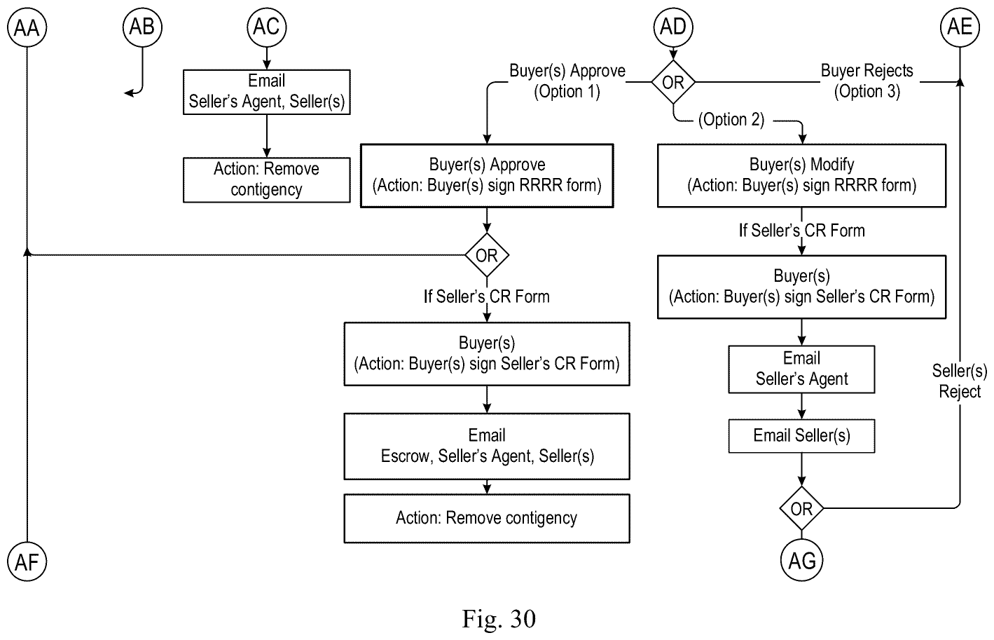

FIG. 30 is a continuation flow diagram of FIG. 29.

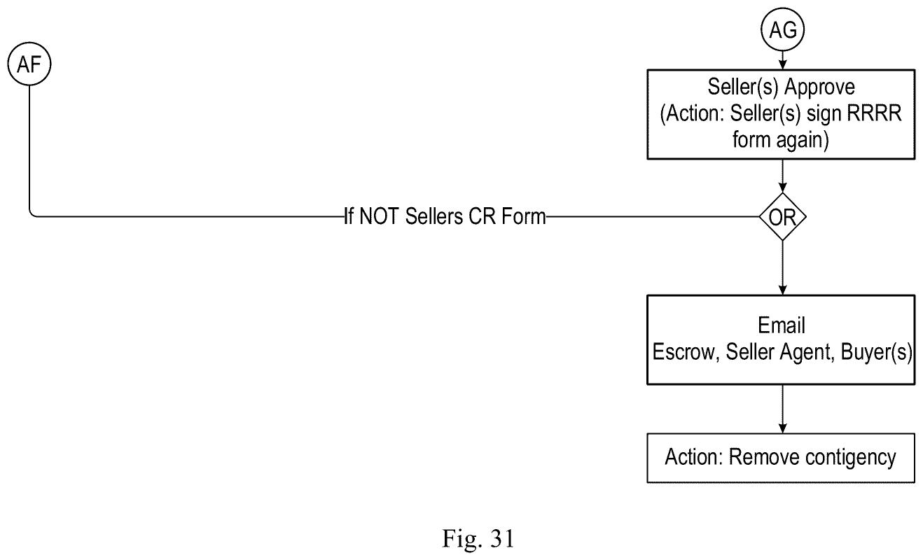

FIG. 31 is a continuation flow diagram of FIG. 30.

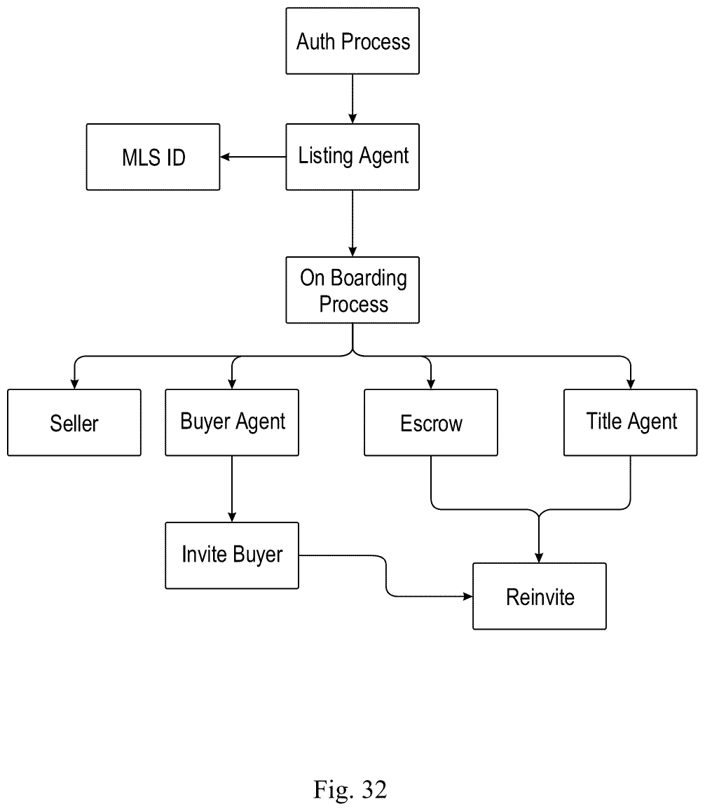

FIG. 32 is a flow diagram of a method for facilitating managing real estate transactions using artificial intelligence, in accordance with some embodiments.

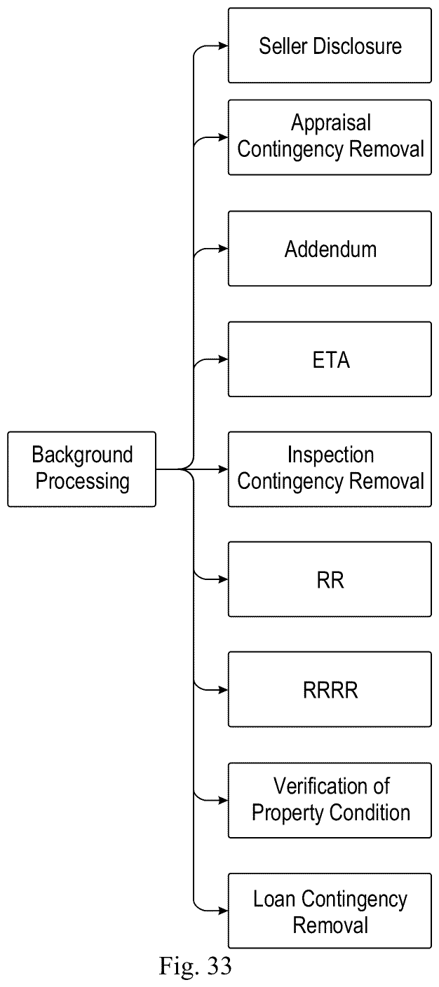

FIG. 33 is a flow diagram of a method for facilitating managing real estate transactions using artificial intelligence, in accordance with some embodiments.

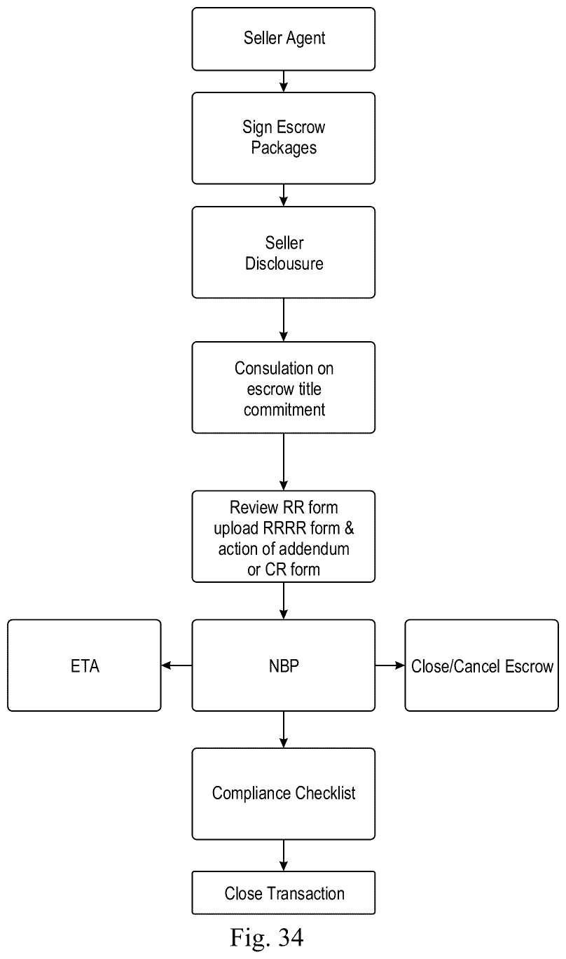

FIG. 34 is a flow diagram of a method for facilitating managing real estate transactions using artificial intelligence, in accordance with some embodiments.

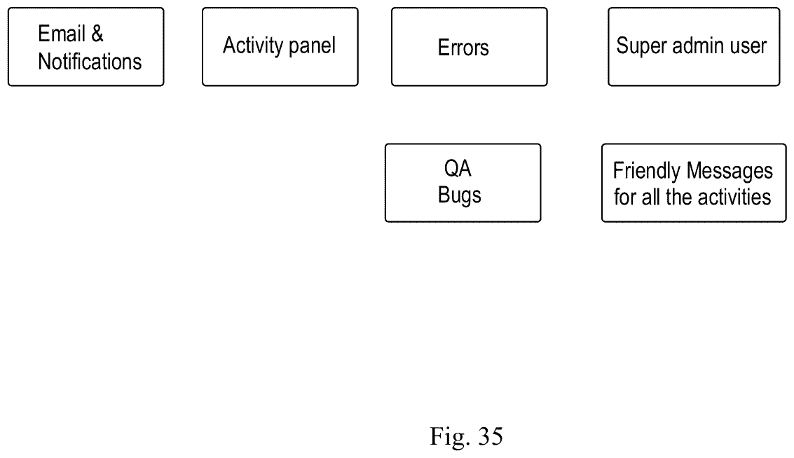

FIG. 35 is a flow diagram of a method for facilitating managing real estate transactions using artificial intelligence, in accordance with some embodiments.

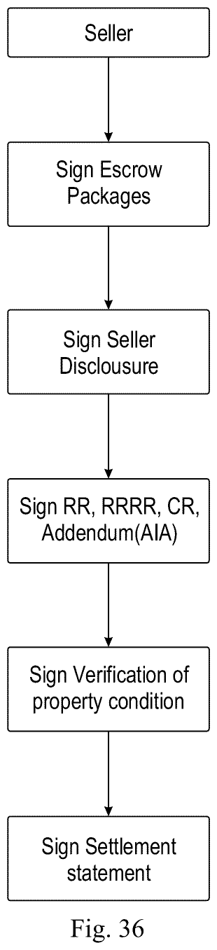

FIG. 36 is a flow diagram of a method for facilitating managing real estate transactions using artificial intelligence, in accordance with some embodiments.

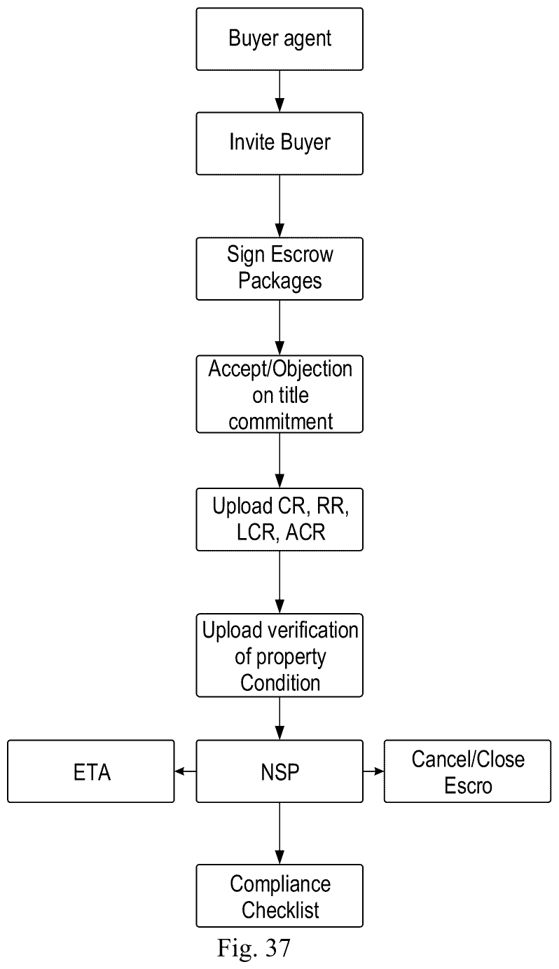

FIG. 37 is a flow diagram of a method for facilitating managing real estate transactions using artificial intelligence, in accordance with some embodiments.

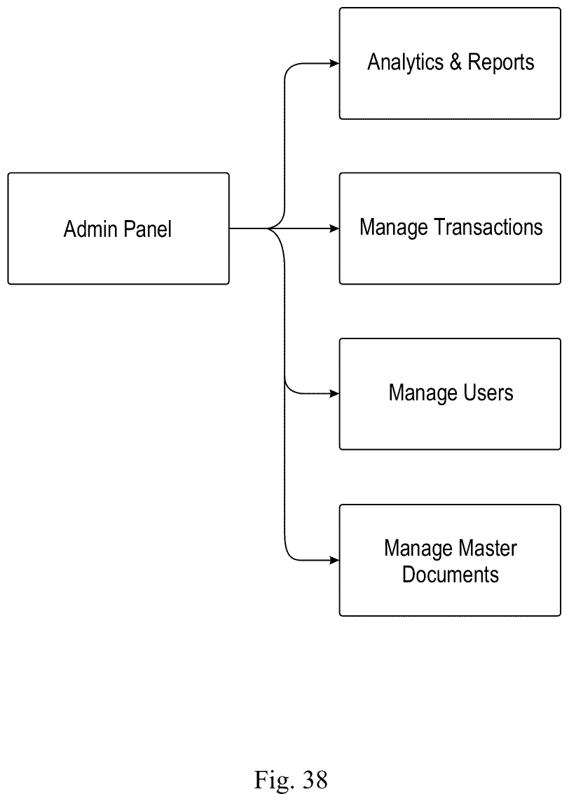

FIG. 38 is a flow diagram of a method for facilitating managing real estate transactions using artificial intelligence, in accordance with some embodiments.

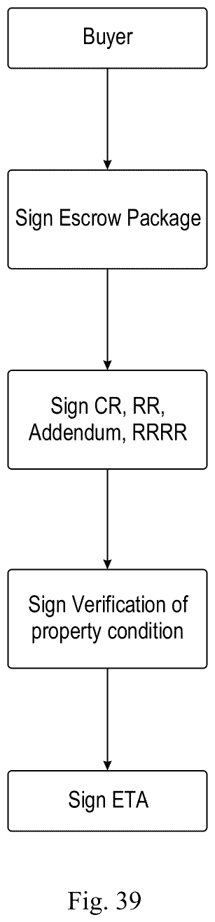

FIG. 39 is a flow diagram of a method for facilitating managing real estate transactions using artificial intelligence, in accordance with some embodiments.

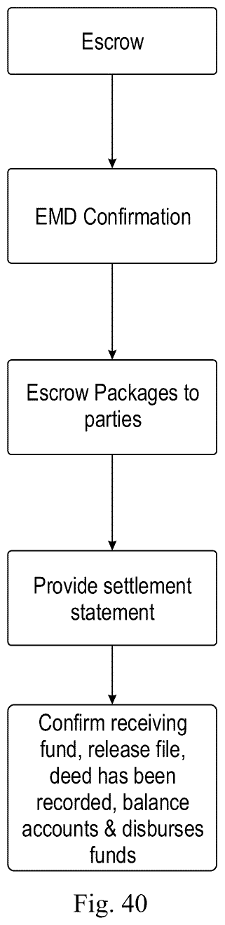

FIG. 40 is a flow diagram of a method for facilitating managing real estate transactions using artificial intelligence, in accordance with some embodiments.

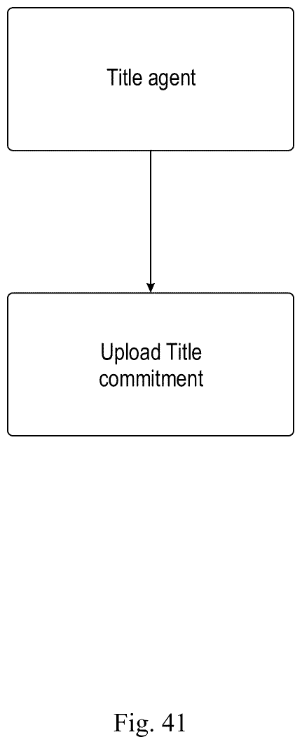

FIG. 41 is a flow diagram of a method for facilitating managing real estate transactions using artificial intelligence, in accordance with some embodiments.

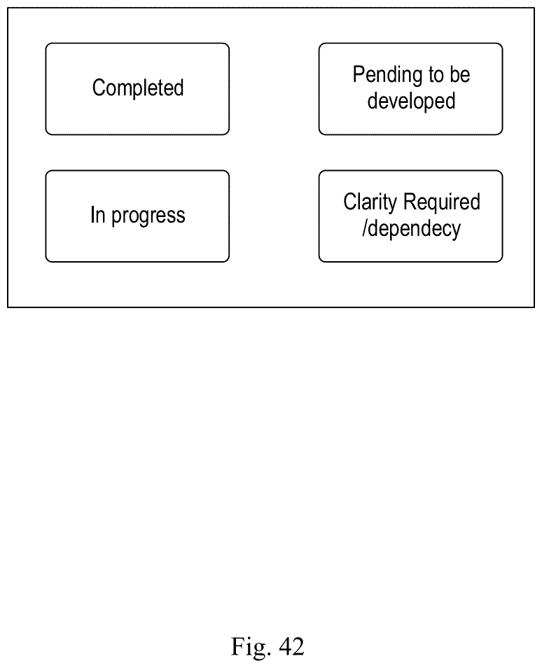

FIG. 42 illustrates a status associated with the real estate transaction, in accordance with some embodiments.

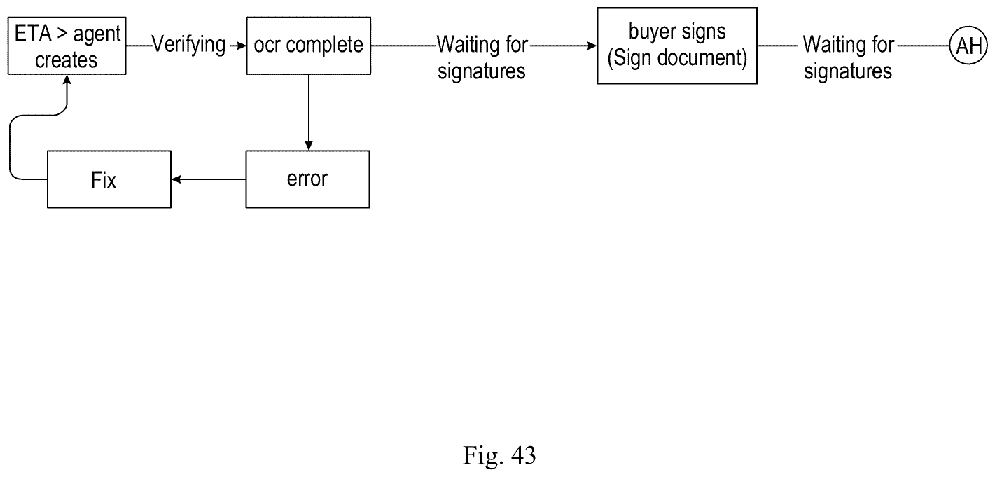

FIG. 43 is a flow diagram of a method for facilitating managing real estate transactions using artificial intelligence, in accordance with some embodiments.

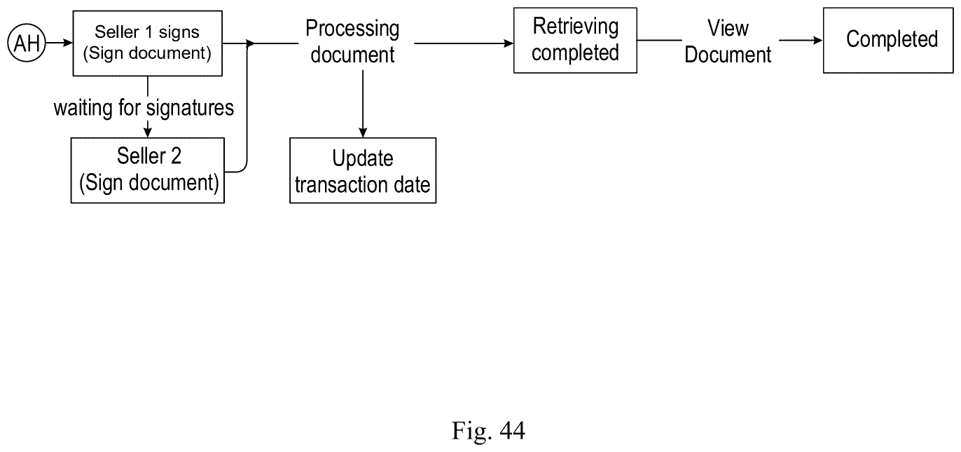

FIG. 44 is a continuation flow diagram of FIG. 43.

Although the invention has been explained in relation to its preferred embodiment, it is to be understood that many other possible modifications and variations can be made without departing from the spirit and scope of the invention as hereinafter claimed.

What is claimed is:

1. A method of facilitating an automated asset transaction, the method comprising:
receiving, using a communication device, an asset transaction data from a user device associated with a user, wherein the asset transaction data corresponds to a transaction associated with an asset;
processing, using a processing device, the asset transaction data;
identifying, using the processing device, a transaction characteristic data based on the processing, wherein the transaction characteristic data corresponds to a characteristic associated with the transaction;
storing, using a storage device, the transaction characteristic data;
generating, using the processing device, a transaction update data based on the transaction characteristic data, wherein the transaction update data corresponds to an update in relation to the transaction, wherein the generating is further based on an AI module; and
transmitting, using the communication device, the transaction update data to the client device.

2. The method of claim 1, wherein the asset comprises a real estate asset, wherein the asset transaction data comprises a real estate document data corresponding to a document associated with the real estate asset, wherein the method further comprising:
analyzing, using the processing device, the real estate document data, wherein the analyzing is based on an OCR module; and
generating, using the processing device, a document extract data based on the analyzing, wherein the document extract data corresponds to an extract of the real estate document, wherein the generating of the transaction update is further based on the document extract data.

3. The method of claim 1 further comprising generating, using the processing device, a transaction ID data based on the identifying of the transaction characteristic data, wherein the transaction ID data represents a transaction ID associated with the transaction, wherein the transaction ID data is comprised in the transaction update data.

4. The method of claim 1, wherein each of the generating of the transaction update data and the storing of the transaction characteristic data is based on an execution of a smart contract, wherein the smart contract is associated with a block-chain network.

5. The method of claim 1, wherein the user device comprises a user presentation device configured for presenting the transaction update data to the user, wherein the user device further comprises a user input device configured for generating a user input data corresponding to a user input in relation to the transaction, wherein the user device further comprises a user communication device configured for transmitting the user input data to the communication device, wherein the method further comprising:
receiving, using the communication device, the user input data from the user device;
processing, using the processing device, the user input data;
generating, using the processing device, a modified transaction update data based on the processing of the user input data, wherein the modified transaction update data corresponds to a modification associated with the update in relation to the transaction; and
transmitting, using the communication device, the modified transaction update data to the user device.

6. The method of claim 1, wherein the asset transaction data comprises a user data corresponding to the user associated with the transaction, wherein the method further comprising validating, using the processing device, the user data, wherein the generating of the transaction update data is further based on the validating, wherein the user data comprises at least one of a user name data corresponding to a name associated with the user and a user signature data corresponding to a signature associated with the user.

7. The method of claim 1 further comprising:
generating, using the processing device, a transaction-based additional insight query data based on the processing of the asset transaction data, wherein the transaction-based additional insight query data corresponds to an additional insight query in relation to the transaction associated with the asset;
transmitting, using the communication device, the transaction-based additional insight query data to an external database; and
receiving, using the communication device, an additional insight data from the external database based on the transmitting of the transaction-based additional insight query data;
processing, using the processing device, the additional insight data, wherein the generating of the transaction update data is further based on the processing of the additional insight data.

8. The method of claim 1 further comprising generating, using the processing device, a legal advisory data based on the processing of the asset transaction data, wherein the generating of the legal advisory data is based on the AI module, wherein the legal advisory data is comprised in the transaction update data.

9. The method of claim 1 further comprising:
generating, using the processing device, a module training data based on each of the transaction update data and the transaction characteristic data;
training, using the processing device, the AI module to obtain a trained AI module, wherein the training is based on the module training data; and
storing, using the storage device, the trained AI module.

10. The method of claim 6 further comprising:
generating, using the processing device, a regulatory query data based on the processing of the asset transaction data, wherein the regulatory query data corresponds to a query associated with a regulatory content in relation to the transaction;
transmitting, using the communication device, the regulatory query data to a regulatory database; and
receiving, using the communication device, a regulatory data from the regulatory database, wherein the generating of the transaction update data is further based on the regulatory data.

11. A system of facilitating an automated asset transaction, the system comprising:
a communication device configured for:
receiving an asset transaction data from a user device associated with a user, wherein the asset transaction data corresponds to a transaction associated with an asset; and
transmitting a transaction update data to the client device;
a processing device configured for:
processing the asset transaction data;
identifying a transaction characteristic data based on the processing, wherein the transaction characteristic data corresponds to a characteristic associated with the transaction; and
generating the transaction update data based on the transaction characteristic data, wherein the transaction update data corresponds to an update in relation to the transaction, wherein the generating is further based on an AI module; and
a storage device configured for storing the transaction characteristic data.

12. The system of claim 11, wherein the asset comprises a real estate asset, wherein the asset transaction data comprises a real estate document data corresponding to a document associated with the real estate asset, wherein the processing device is further configured for:
analyzing the real estate document data, wherein the analyzing is based on an OCR module; and
generating a document extract data based on the analyzing, wherein the document extract data corresponds to an extract of the real estate document, wherein the generating of the transaction update is further based on the document extract data.

13. The system of claim 11, wherein the processing device is further configured for generating a transaction ID data based on the identifying of the transaction characteristic data, wherein the transaction ID data represents a transaction ID associated with the transaction, wherein the transaction ID data is comprised in the transaction update data.

14. The system of claim 11, wherein each of the generating of the transaction update data and the storing of the transaction characteristic data is based on an execution of a smart contract, wherein the smart contract is associated with a block-chain network.

15. The system of claim 11, wherein the user device comprises a user presentation device configured for presenting the transaction update data to the user, wherein the user device further comprises a user input device configured for generating a user input data corresponding to a user input in relation to the transaction, wherein the user device further comprises a user communication device configured for transmitting the user input data to the communication device, wherein the communication device is further configured for:
receiving the user input data from the user device; and
transmitting a modified transaction update data to the user device, wherein the processing device is further configured for:
processing the user input data;
generating the modified transaction update data based on the processing of the user input data, wherein the modified transaction update data corresponds to a modification associated with the update in relation to the transaction.

16. The system of claim 11, wherein the asset transaction data comprises a user data corresponding to the user associated with the transaction, wherein the processing device is further configured for validating the user data, wherein the generating of the transaction update data is further based on the validating, wherein the user data comprises at least one of a user name data corresponding to a name associated with the user and a user signature data corresponding to a signature associated with the user.

17. The system of claim 11, wherein the processing device is further configured for:
generating a transaction-based additional insight query data based on the processing of the asset transaction data, wherein the transaction-based additional insight query data corresponds to an additional insight query in relation to the transaction associated with the asset; and
processing an additional insight data, wherein the generating of the transaction update data is further based on the processing of the additional insight data, wherein the communication device is further configured for:
transmitting the transaction-based additional insight query data to an external database; and
receiving the additional insight data from the external database based on the transmitting of the transaction-based additional insight query data.

18. The system of claim 11, wherein the processing device is further configured for generating a legal advisory data based on the processing of the asset transaction data, wherein the generating of the legal advisory data is based on the AI module, wherein the legal advisory data is comprised in the transaction update data.

19. The system of claim 11, wherein the processing device is further configured for:
generating a module training data based on each of the transaction update data and the transaction characteristic data; and
training the AI module to obtain a trained AI module, wherein the training is based on the module training data, wherein the storage device is further configured for storing the trained AI module.

20. The system of claim 16, wherein the processing device is further configured for generating a regulatory query data based on the processing of the asset transaction data, wherein the regulatory query data corresponds to a query associated with a regulatory content in relation to the transaction, wherein the communication device is further configured for:
transmitting the regulatory query data to a regulatory database; and
receiving a regulatory data from the regulatory database, wherein the generating of the transaction update data is further based on the regulatory data.
